(19) United States
(12) Patent Application Publication
(10) Pub. No.: US 2026/0289119 A1
(43) Pub. Date: Sep. 24, 2026

(54) SYSTEM

(71) Applicant: SoftBank Group Corp., Tokyo (JP)

(72) Inventor: Shingo ONO, Tokyo (JP)

(73) Assignee: SoftBank Group Corp., Tokyo (JP)

(21) Appl. No.: 19/568,922

(22) Filed: Mar. 17, 2026

(30) Foreign Application Priority Data
Mar. 19, 2025 (JP) 2025-045171

(51) Int. Cl. G06F 40/279; G10L 25/63

(52) U.S. Cl. CPC G06F 40/279; G10L 25/63

(57) ABSTRACT

A system includes a processor that is configured to analyze information received from a user by using a generative AI model, and automatically generate a personality prompt that instructs a specific behavior or reaction, enable the generated personality prompt to be customized by allowing the user to edit or add to the generated personality prompt through an interface, and monitor an emotional state of the user in real time and dynamically adjust the personality prompt in accordance with the emotional state of the user.

### CROSS-REFERENCE TO RELATED APPLICATION

This application is based on and claims priority under 35 USC 119 from Japanese Patent Application No. 2025-045171 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for defining and controlling character behavior in interactive systems, such as conversational agents, game characters, or virtual assistants, typically rely on manually crafted rules, static scripts, or simple parameter settings. In such conventional systems, a user is required to explicitly design and write detailed behavioral instructions for a character, which demands specialized knowledge and significant time, and makes it difficult for non-expert users to create rich and consistent personalities. Furthermore, conventional systems generally do not incorporate real-time emotional state information of the user and therefore cannot appropriately adapt the personality or behavioral instructions in response to changes in the user's emotional condition. As a result, interaction quality, user engagement, and personalization are limited, and the system cannot flexibly respond to diverse contexts or user needs. Accordingly, there is a need for a system that can automatically generate personality prompts instructing specific behaviors or reactions by using a generative AI model based on user information, that allows easy customization of the prompts by the user, and that dynamically adjusts the prompts in real time based on the user's emotional state, thereby improving usability, adaptability, and expressiveness of character behavior.

### SUMMARY

In order to solve the above-described problems, a system according to one embodiment of the present invention comprises a processor, wherein the processor is configured to analyze information received from a user by using a generative AI model, and automatically generate a personality prompt that instructs a specific behavior or reaction, enable the generated personality prompt to be customized by allowing the user to edit or add to the generated personality prompt through an interface, and monitor an emotional state of the user in real time and dynamically adjust the personality prompt in accordance with the emotional state of the user. In one aspect, the processor is configured to use the generative AI model to generate a prompt that instructs a behavior or reaction of a specific character, so that the user can easily define and refine character-specific behavioral patterns without manually writing complex rules. In another aspect, the processor is configured to use the generative AI model to provide reference information for the user when the user considers a new personality prompt, thereby supporting creative exploration and reducing the burden on the user when designing new character personalities. By integrating automatic generation, user-driven customization, and real-time emotional-state-based adjustment of personality prompts, the system enables flexible, personalized, and context-aware control of character behavior and reactions.

The term “system” refers to an aggregation of hardware and software components, including at least one processor and associated memory and interfaces, that cooperatively perform the operations described in the present specification and claims.

The term “processor” refers to one or more hardware processing units, such as a central processing unit (CPU), a graphics processing unit (GPU), a microcontroller, or a combination thereof, that executes instructions to carry out the functions specified in the present specification and claims.

The term “generative AI model” refers to a machine learning model, such as a large language model or other neural network-based model, that is trained on data to generate new content, including natural language text, in response to input information.

The term “information received from a user” refers to any data provided directly or indirectly by the user to the system, including but not limited to textual input, selections made through a user interface, profile data, and interaction history.

The term “analyze” refers to processing input data, such as information received from a user, to extract features, identify patterns, infer intent or context, or otherwise interpret the data in a manner that enables subsequent generation or adjustment of personality prompts.

The term “personality prompt” refers to a natural language instruction or set of instructions that defines or influences how a character or system entity should behave, react, or respond, including specific behaviors, attitudes, styles of expression, or emotional tendencies.

The term “automatically generate” refers to creating content, such as a personality prompt, by computational processing performed by the system without requiring the user to manually write or explicitly specify the complete content.

The term “specific behavior or reaction” refers to a particular action, response, or pattern of conduct of a character or system agent, such as how the character speaks, acts in certain situations, or responds to user input or contextual events.

The term “customized” refers to being modified, refined, or extended from an initial automatically generated state based on user input, so that the resulting personality prompt more closely matches the user's intended character or use case.

The term “interface” refers to a hardware and/or software component that enables interaction between the user and the system, including but not limited to graphical user interfaces, web interfaces, mobile application interfaces, or other input/output mechanisms.

The term “edit” refers to modifying an existing personality prompt, including changing wording, adding or removing portions of text, or rephrasing instructions, by using the interface provided by the system.

The term “add” refers to creating and appending a new personality prompt or additional instruction that was not part of the original automatically generated set of prompts.

The term “emotional state of the user” refers to an inferred or detected psychological condition of the user, such as happiness, sadness, frustration, excitement, or calmness, obtained through analysis of user input, biometric signals, behavioral patterns, or other indicators.

The term “monitor in real time” refers to continuously or periodically observing and updating information, such as the emotional state of the user, with a latency that is sufficiently low for the system to respond during an ongoing interaction session.

The term “dynamically adjust” refers to modifying a personality prompt or set of prompts during operation of the system, in response to changing conditions, such as a change in the user's emotional state, without requiring the user to restart the system or manually reconfigure all prompts.

The term “prompt that instructs a behavior or reaction of a specific character” refers to a personality prompt that is explicitly associated with a designated character, persona, or role, and that describes how that particular character should act, respond, or speak in given situations.

The term “reference information” refers to example prompts, suggestions, guidelines, archetypes, or other auxiliary data generated or provided by the system to assist the user in conceiving, designing, or refining new personality prompts.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

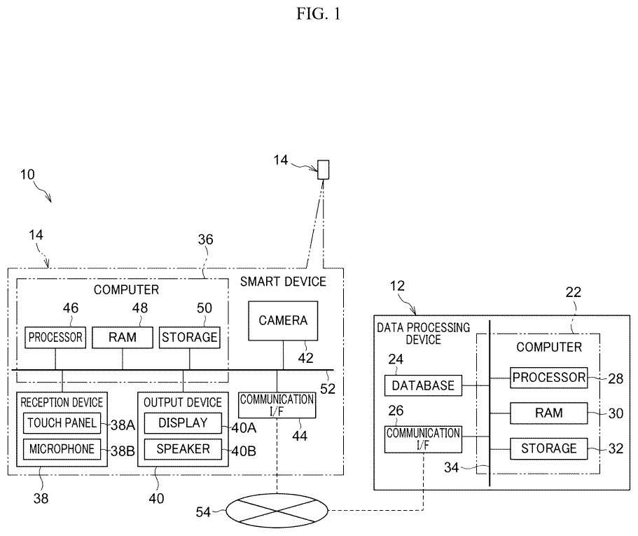

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

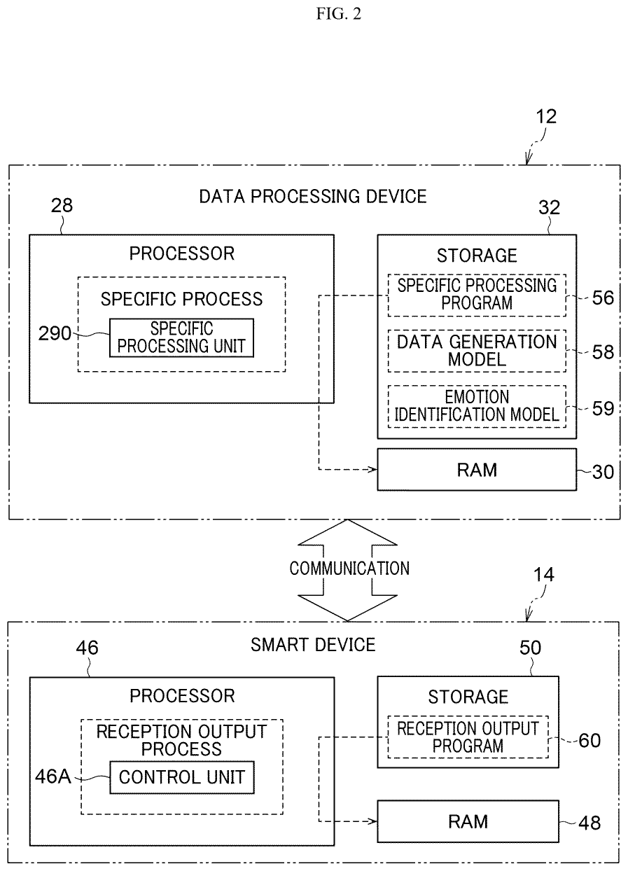

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems that assist users in defining personalities of virtual agents or characters using a generative AI model typically accept free-form textual descriptions from users and directly forward such descriptions to the generative AI model. In such systems, the generative AI model produces a prompt sentence or similar output without any structured interpretation of the user input. As a result, several technical problems arise in the context of computer technology.

First, because the user input is handled as unstructured natural language, the processing unit cannot reliably extract role information, personality information, or typical behavior information. The lack of structured representation leads to unstable mapping between input and output, reduces reproducibility of results, and increases the computational burden on the generative AI model, which must internally infer structure that could have been pre-computed by the system itself. This results in inefficient utilization of computational resources in the processing unit and in the generative AI model.

Second, conventional systems do not normalize synonymous expressions or map them to higher-level concepts prior to generating a personality prompt. Accordingly, semantic redundancy and variation in the input text cause the generative AI model to generate prompt sentences with inconsistent style, length, and instruction format. This inconsistency degrades the suitability of the generated prompt sentences as machine-consumable control inputs for downstream generative AI models, and requires repeated trial-and-error interaction by the user. From a systems perspective, this leads to increased network traffic and processor cycles due to repeated generation and correction.

Third, many existing systems treat a user's emotional state only implicitly, if at all. They do not acquire user emotional state information from operation information or terminal state information, and thus cannot adapt generation conditions or the contents of the personality prompt in real time. This inability to dynamically adjust generation behavior based on user state reduces the responsiveness and adaptability of the system as an interactive computing environment, and may cause the generative AI model to continue generating prompts that do not align with changing user needs, thereby wasting processing capacity and interface bandwidth.

Fourth, conventional configurations do not provide systematic support for the user to construct new personality prompts. They often lack a mechanism to derive and present candidate phrases and sample prompt sentences from structured data produced from prior inputs. Consequently, users must repeatedly design prompts manually, which increases cognitive load and leads to inefficient usage of the computing resources of both the server and the generative AI model, as the same or similar semantic content is generated redundantly.

Accordingly, there is a need for a technical solution that, in the context of a computer-implemented system including a processor and a generative AI model, (i) converts unstructured character description text into structured data via normalization and natural language processing, (ii) generates controlled-format personality prompts as prompt sentences that can be reliably reused as inputs to other generative AI models, (iii) dynamically modifies input conditions or prompt contents based on a detected emotional state of the user, and (iv) assists the user by presenting candidate phrases and sample prompts. Such a solution improves the efficiency, stability, and adaptability of the underlying computer system, rather than merely providing a new presentation of content to the user.

The specific processing by the specific processing unit 290 of the data processing device 12 in Example 1 is realized by the following means.

The present invention provides a server comprising a processor configured to receive character description text from a terminal, normalize the character description text, perform natural language processing on the normalized character description text to extract attribute information and behavior information of a person, convert the extracted attribute information and behavior information into structured data, generate, based on the structured data, an input sentence for a generative AI model, cause the generative AI model to generate a prompt sentence as a personality prompt that instructs actions and reactions of the person and control an expression format and a length of the prompt sentence so that the prompt sentence is in a form of instructions directed to the person, output the generated prompt sentence to the terminal, enable a user to customize the prompt sentence by editing or adding to the prompt sentence via an interface of the terminal, present a customized prompt sentence as a prompt sentence to be input to another generative AI model, acquire an emotional state of the user based on operation information of the user and state information obtained from the terminal, dynamically change an input condition to the generative AI model or contents of the prompt sentence in accordance with the acquired emotional state of the user, generate the structured data by integrating synonymous expressions in the character description text into higher-level concepts using the natural language processing and generate, in accordance with role information, personality information, and typical behavior information included in the structured data, the prompt sentence as the personality prompt that includes specific action instructions in a plurality of situations, and present candidate phrases and sample prompt sentences, generated on the basis of the structured data and the generative AI model, as reference information when the user creates a new prompt sentence as the personality prompt. This enables the computer-implemented system to offload structural inference from the generative AI model to a dedicated preprocessing pipeline, reduce variability in generated prompt sentences, adapt prompt generation behavior in real time based on user emotional state, and efficiently reuse and refine personality prompts as machine-readable control inputs for downstream generative AI models, thereby improving overall processing efficiency, responsiveness, and reliability of the server and associated computational resources.

The term “terminal” refers to an information processing device operated by a user, such as a general-purpose computing device or communication device, that transmits character description text and related information to the server and receives prompt sentences and other responses from the server via a communication network.

The term “character description text” refers to natural language text input by a user via the terminal, the text describing attributes, roles, behaviors, or other characteristics of a person, virtual agent, or character to be modeled by the system.

The term “normalize” refers to processing that converts input text into a unified representation by operations such as character set conversion, whitespace adjustment, formatting standardization, or encoding unification so that subsequent natural language processing can be performed in a consistent manner.

The term “natural language processing” refers to processing that analyzes and manipulates human language data by computational methods, including at least one of tokenization, part-of-speech tagging, phrase extraction, named-entity recognition, semantic analysis, or synonym detection.

The term “attribute information” refers to information representing relatively stable characteristics of a person or character, including at least one of role type, personality traits, disposition, or background properties derived from the character description text.

The term “behavior information” refers to information representing actions, reactions, or typical behavioral patterns of a person or character, including at least one of explicit action verbs, typical scenarios, or context-dependent reactions extracted from the character description text.

The term “structured data” refers to data obtained by organizing the attribute information and behavior information into a machine-readable format, such as records, fields, tags, or key-value pairs, in which semantic elements are explicitly separated and labeled.

The term “higher-level concepts” refers to abstracted semantic categories obtained by grouping multiple synonymous or related expressions, the categories representing generalized notions such as roles, traits, or behaviors rather than individual surface forms of words or phrases.

The term “generative AI model” refers to a trained computational model that generates new natural language text in response to input data, the model being implemented, for example, by a neural network architecture such as a transformer and being capable of probabilistic sequence generation.

The term “input sentence for a generative AI model” refers to a natural language instruction or query that is constructed by the processor based on structured data and that is supplied to the generative AI model as input for generating an output text.

The term “prompt sentence” refers to a natural language text generated by the generative AI model that is designed to guide or control subsequent operation of another generative model or system by specifying desired behaviors, styles, or constraints.

The term “personality prompt” refers to a specific type of prompt sentence that describes stable characteristics, actions, and reactions of a person or character in an instruction-like format, enabling consistent behavior when used as context for another generative AI model.

The term “expression format” refers to structural and stylistic properties of a prompt sentence, including at least one of grammatical person, sentence structure, imperative or descriptive tone, and ordering of information, which are controlled so that the prompt functions as instructions directed to a character.

The term “length of the prompt sentence” refers to a quantitative measure of the size of the generated text, such as the number of characters, tokens, or sentences, which is controlled by the processor to satisfy predetermined constraints.

The term “customize the prompt sentence” refers to modifying or augmenting a generated prompt sentence by user operations via the terminal, including at least one of editing, deleting, adding, or reordering portions of the text.

The term “another generative AI model” refers to a generative AI model that is distinct from, or separately instantiated from, the generative AI model used to generate the personality prompt, and that uses the personality prompt as an input condition to generate further content such as narratives or dialogues.

The term “operation information” refers to data representing user interactions with the terminal or server-side interface, including at least one of key inputs, pointer or touch operations, selection events, input time, or frequency of regeneration requests.

The term “state information obtained from the terminal” refers to information acquired from the terminal regarding its usage state or environment, including at least one of display context, interaction history, response times, or other contextual metadata that is indicative of user engagement or condition.

The term “emotional state of the user” refers to a state inferred or determined by the processor based on operation information and state information, the state representing at least one of satisfaction, frustration, confusion, interest, or similar affective conditions of the user.

The term “input condition to the generative AI model” refers to a set of parameters and control information used when invoking the generative AI model, including at least one of temperature, maximum length, sampling strategy, role instructions, or additional conditioning text.

The term “role information” refers to structured data indicating the functional or narrative role of a character, such as a profession, archetype, or social position, derived from the character description text and mapped to higher-level concepts.

The term “personality information” refers to structured data indicating psychological or dispositional traits of a character, such as bravery, intelligence, kindness, or similar qualities, normalized into higher-level concepts.

The term “typical behavior information” refers to structured data describing recurring or characteristic actions of a character across a plurality of situations, such as common reactions to danger, conflict, or interaction with other entities.

The term “specific action instructions in a plurality of situations” refers to directive statements within a personality prompt that describe how a character should act or react in multiple different contextual scenarios, expressed in a way that can guide behavior generation by a generative AI model.

The term “candidate phrases” refers to partial textual elements derived from the structured data and optionally refined by the generative AI model, which the processor presents as reusable building blocks for constructing or modifying personality prompts.

The term “sample prompt sentences” refers to complete example prompt sentences generated on the basis of the structured data and the generative AI model, which are presented to the user as reference templates for creating or refining personality prompts.

In the following embodiments, a data processing device is referred to as a server, and a user-operated information processing device is referred to as a terminal. A user operates the terminal to interact with the server over a communication network.

The server includes at least one processor, a memory, a non-volatile storage device, and a communication interface. The server is implemented, for example, by a general-purpose computer system or a cluster of such systems equipped with one or more central processing units and, optionally, one or more graphics processing units. The server executes an operating system such as a general-purpose server operating system and runs application programs that implement the natural language processing functions, the generative AI model invocation, the structured data management, and the emotional state estimation described below.

The terminal includes at least one processor, a memory, a display device, an input interface, and a communication interface. The terminal is realized, for example, by a smart phone, a tablet, a notebook computer, or a desktop computer. The terminal executes a browser program or a dedicated application program and communicates with the server via a wired or wireless network using a standardized communication protocol.

The server stores in the memory a plurality of software modules, including a communication control module, a text normalization module, a natural language processing module, a concept mapping module, a structured data management module, a prompt generation control module, a generative AI interface module, an emotional state estimation module, and a user support module for generating candidate phrases and sample prompt sentences. Each module is realized, for example, as a program component executed by the processor of the server.

The server uses the text normalization module to process character description text received from the terminal. The server converts the input text to a unified character encoding, performs normalization of punctuation and spacing, and unifies different notation styles. The server thereby creates a normalized text string suitable for subsequent analysis. By performing this normalization on the server side, the server reduces the variability of input tokens supplied to downstream processing modules, which reduces memory consumption for token dictionaries and improves cache locality when executing token-based algorithms.

The server uses the natural language processing module to analyze the normalized text string.

The server performs tokenization to divide the text into tokens, performs part-of-speech tagging to label each token with grammatical information, and performs phrase extraction to identify noun phrases, verb phrases, and other syntactic units. The server may implement these functions by executing a pre-trained language analysis model such as a sequence labeling model or a transformer-based encoder. In one embodiment, the server uses a multi-layer neural network encoder that maps tokens to vector representations, applies self-attention to compute contextualized embeddings, and outputs tag labels for each position based on a classification layer.

The server uses the concept mapping module to map extracted tokens and phrases to higher-level concepts. The server stores a concept dictionary that includes mappings from surface expressions, such as “brave” or “courageous,” to abstract trait identifiers, such as a bravery trait concept. The server applies rules and similarity thresholds to determine which higher-level concept should be assigned to each expression. For example, the server calculates cosine similarity between word embeddings of the input phrase and representative embeddings of candidate concepts, and selects a concept whose similarity exceeds a predetermined threshold. By performing this mapping, the server reduces synonymous variation and produces a compact, normalized representation of character traits and roles.

The server uses the structured data management module to construct structured data that represents attribute information, behavior information, and other elements of the character.

The server stores this structured data in a machine-readable format such as key-value pairs or records. For example, the server stores role information, personality traits, and typical behaviors in separate fields. The server can index these fields to enable efficient retrieval and update. This structured representation allows the server to compute deterministic transformations from character descriptions to prompt sentences, rather than relying solely on opaque inference inside a generative AI model.

The server uses the prompt generation control module and the generative AI interface module to generate a personality prompt in the form of a prompt sentence. The server composes an input sentence for a generative AI model using the structured data. The server concatenates template phrases with the normalized role information, personality information, and typical behavior information. The server supplies the resulting input sentence as a user instruction to the generative AI model.

The server implements the generative AI model as a neural network-based language generation model stored on the server or accessible via a network. The generative AI model is, for example, a transformer-based autoregressive model that includes an embedding layer, a plurality of self-attention blocks, and a linear output layer with a softmax function. The server stores model parameters trained in advance on large-scale text data. The server uses a loss function such as cross-entropy loss during the model's pre-training phase, and updates model weights via stochastic gradient descent or a variant such as the Adam optimizer. In some embodiments, the server performs fine-tuning of the generative AI model using additional training data consisting of pairs of structured data and desirable personality prompts to align the output more closely with the structured representation.

The server, during runtime, converts the composed input sentence into tokens using a tokenizer consistent with the generative AI model's vocabulary. The server supplies the tokens to the model, which performs forward passes through the transformer blocks. In each block, the model computes self-attention scores between token representations, applies weighted summation, performs non-linear transformation using feed-forward sub-layers, and propagates the updated representations to subsequent layers. The output layer converts the final hidden state at each position into a probability distribution over the vocabulary. The server selects tokens according to a sampling strategy, such as greedy decoding, top-k sampling, or nucleus sampling, under the control of generation parameters such as temperature and maximum length. The server thereby obtains generated text that constitutes a personality prompt as a prompt sentence.

The server uses the prompt generation control module to enforce constraints on the expression format and length of the generated prompt sentence. The server specifies, in the input sentence and in the generation parameters, that the personality prompt should be written in the second person and should contain imperative or instruction-like statements. For example, the server includes phrases such as “You are” and “You must” in the input sentence and sets a maximum token length to avoid excessively long output. The server may post-process the generated text by detecting pronouns and verb forms and rewriting any third-person expressions into second-person expressions using rule-based transformations or auxiliary parsing models. This combination of preconditioning and post-processing ensures that the prompt sentence conforms to a consistent instruction style usable as an input control signal for another generative AI model.

The server, after generating the prompt sentence, transmits the text to the terminal via the communication control module. The terminal displays the prompt sentence on its display device. The user views the text and, if desired, edits or adds to the prompt sentence using an input interface such as a keyboard or a touch screen. The server receives edited versions of the prompt sentence from the terminal and stores the customized prompt sentences in the structured data storage. The server can transmit these customized prompt sentences to other models or external systems as standardized prompt sentences for use in subsequent content generation tasks.

The server uses the emotional state estimation module to estimate an emotional state of the user. The server collects operation information, such as the frequency of regeneration requests, the time intervals between user actions, the number of editing operations, and error corrections. The server also obtains state information from the terminal, such as viewport changes, scrolling behavior, and interaction patterns. The server aggregates these signals and inputs them into an estimation model, which may be a separate neural network or a rule-based classifier.

In one embodiment, the server implements the estimation model as a feed-forward neural network that takes as input a feature vector constructed from operation counts, temporal intervals, and interaction types. The server trains the model using labeled data associating feature vectors with emotional labels such as satisfaction, frustration, or confusion. The server uses a loss function such as categorical cross-entropy to adjust the model parameters.

During operation, the server uses the trained model to predict an emotional state for each user session. The server adapts generation parameters for the generative AI model based on the predicted state. For example, if the server detects repeated prompt regeneration in a short time, the server may increase the level of detail in the prompt sentence or adjust the style to be simpler and more direct. By adjusting input conditions dynamically based on estimated emotional state, the server reduces the number of iterations required to reach a satisfactory prompt and thereby reduces processing load and network traffic.

The server uses the user support module to assist the user in creating new personality prompts. The server derives candidate phrases from the structured data by combining role identifiers, trait identifiers, and behavior identifiers into partial sentences. For example, the server generates candidate phrases such as “never retreats in the face of danger” or “explains deductions clearly and calmly.” The server may refine these candidate phrases by supplying the structured data to the generative AI model with instructions to produce short, reusable fragments rather than full prompts. The server then presents these candidate phrases to the user via the terminal. The user can insert selected candidate phrases into a prompt sentence or use them as templates for manual editing.

The server also generates sample prompt sentences as complete examples. The server uses the structured data and the generative AI model to generate multiple alternative personality prompts for a particular character description. For instance, in response to a description of a brave knight, the server may generate a prompt sentence such as:
“You are a brave knight sworn to protect the innocent. You stand fearlessly before dragons, shield villagers from danger, and never abandon those in need. In every decision, you choose courage and honor over fear or selfishness.”

In response to a description of an intelligent detective, the server may generate a prompt sentence such as:
“You are an intelligent detective who approaches every case with calm, methodical logic. You rely on keen observation, subtle clues, and rigorous deduction to uncover the truth. You question every assumption and explain your reasoning clearly as you solve mysteries.”

The server presents such sample prompt sentences to the user, enabling the user to understand the relationship between the structured data and the resulting instructions. This guidance reduces the cognitive burden on the user and promotes the creation of machine-usable prompt sentences with consistent structure.

The server, by performing normalization, structured representation, and concept mapping prior to invoking the generative AI model, improves computational efficiency and stability compared to a configuration in which raw user text is directly supplied to the generative AI model. Because the server supplies a more constrained and semantically clarified input sentence to the generative AI model, the search space for token generation is effectively reduced, which can lower the number of tokens processed and accelerate generation. The structured representation also allows the server to re-use parts of the analysis for different generation tasks, thereby avoiding repeated full inference inside the generative AI model.

The server, by enforcing a standardized instruction format for personality prompts and storing them as reusable artifacts, improves interoperability between different generative AI models and applications. Because the prompt sentences follow a consistent structure and length, downstream models can process them with more predictable performance. This reduces the need for ad-hoc prompt engineering at the application layer and allows the server to serve as a central prompt management and optimization component.

The server applies non-conventional processing rules that differ from human manual prompt writing. The server uses quantitative similarity measures, vector-based clustering, and structured abstraction to unify synonymous expressions into higher-level concepts. The server controls generation parameters and enforces second-person instruction style using algorithmic criteria rather than subjective judgment. These procedures implement a technical pipeline that is not a mere automation of human writing, but a distinct form of computational optimization that leverages the properties of neural network architectures and structured storage.

The server can adopt alternative embodiments for the generative AI model and the emotional state estimation model. In some embodiments, the server deploys a smaller model for local inference and a larger model for high-quality generation. The server may select a model based on network conditions, available processing capacity, or user preferences. In other embodiments, the server uses rule-based emotional state estimation, in which thresholds on operation counts and response times determine emotional categories, and adjusts generation parameters accordingly. In still other embodiments, the server combines rule-based and learned models in an ensemble to improve robustness.

The server can be integrated into content creation workflows, simulation systems, or interactive entertainment platforms. The server provides personality prompts as control inputs to non-player characters in simulation engines or to automated dialogue systems. Because the personality prompts produced by the server are structurally consistent and compact, the simulation or dialogue engines can parse and interpret them more reliably, leading to more predictable character behavior and reduced processing overhead in the simulation engine.

The server, by unifying unstructured user input into structured data, applying a transformer-based generative AI model with controlled input and output, and dynamically adapting behavior based on measured interaction signals, improves the underlying computer technology involved in natural language interface processing. The combination of modules and algorithms described above yields technical effects including increased generation speed due to constrained input space, improved accuracy and stability of generated prompt sentences due to normalized concept mapping, reduced network and processing load due to decreased need for repeated prompt regeneration, and improved management of prompt data due to structured storage and re-use. These effects arise from specific data structures, algorithmic flows, and model configurations implemented in the server, and thus constitute improvements to computer functionality rather than a mere automation of mental processes.

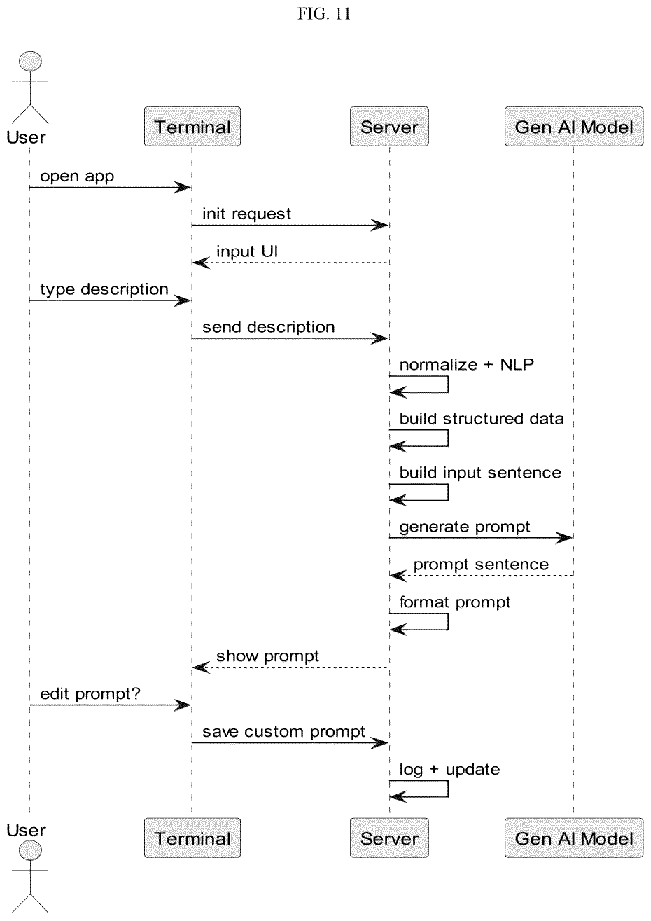

The following describes the processing flow using FIG. 11.

### Step 1:

The user operates the terminal to open an application or browser and access the server over a network.
The input to this step is a request from the user to start a character definition session.
The terminal sends an initial HTTP request to the server and receives markup and script data.
The output of this step is that the terminal displays an input screen including a text field for character description and optional controls for additional settings.

### Step 2:

The user uses the terminal to input character description text, such as “A brave knight who fights dragons and protects villagers” or “An intelligent detective who uses logical reasoning and keen observation,” and optionally selects supplementary options such as genre or style.
The input to this step is the user's keystrokes, touch operations, and selection operations on the terminal interface.
The terminal aggregates the text and selected options into a data structure and transmits the aggregated data to the server via an HTTP request.
The output of this step is that the server receives a character description payload containing at least one natural language string to be processed.

### Step 3:

The server uses a communication module to parse the received HTTP request and extract the character description text and any additional parameters.
The input to this step is the raw request data from the terminal, including headers and a body containing the character description.
The server validates the existence of mandatory fields, checks length limits, and verifies character encoding; if necessary, the server converts the text to a standard encoding.
The output of this step is a validated text string and associated parameters suitable for internal processing; if validation fails, the output is an error response returned to the terminal.

### Step 4:

The server uses a text normalization module to normalize the validated character description text.
The input to this step is the raw character description string.
The server performs operations such as trimming excess whitespace, standardizing punctuation, normalizing Unicode representations, and optionally converting case or character width.
The output of this step is a normalized text string that reduces extraneous variation and serves as an input to natural language processing.

### Step 5:

The server uses a natural language processing module to analyze the normalized text string and extract attribute information and behavior information.
The input to this step is the normalized text string.
The server tokenizes the string into tokens, assigns part-of-speech tags, and identifies phrase boundaries, then applies parsing or sequence labeling to identify role expressions (for example, “knight,” “detective”), trait expressions (for example, “brave,” “intelligent”), and behavior expressions (for example, “fights dragons,” “protects villagers,” “uses logical reasoning”).
The output of this step is an intermediate representation that lists extracted tokens and phrases annotated with semantic labels, such as role, trait, or behavior.

### Step 6:

The server uses a concept mapping module to convert extracted expressions into higher-level concepts and to construct structured data.
The input to this step is the annotated list of extracted phrases produced by the natural language processing module.
The server consults a concept dictionary and computes similarities between phrase embeddings and concept embeddings, applies thresholds, and maps synonymous or related expressions to unified concept identifiers for roles, personality traits, and typical behaviors.
The output of this step is structured data, for example a record containing fields such as role information, personality information, and typical behavior information, each represented by normalized concept identifiers rather than raw text.

### Step 7:

The server uses a structured data management module to store and organize the structured data and to prepare it for generation.
The input to this step is the structured data object containing concept identifiers and associated attributes.
The server assigns a session identifier, stores the structured data in a database or memory store, and may derive additional metadata, such as counts of traits or ranking of behaviors, using simple arithmetic operations or heuristic scoring.
The output of this step is a persistent or semi-persistent structured record indexed by the session identifier, which can be referenced by subsequent generation modules.

### Step 8:

The server uses a prompt generation control module to compose an input sentence for a generative AI model from the structured data.
The input to this step is the structured record containing role, personality, and behavior concept identifiers.
The server retrieves template sentences, substitutes the normalized role and trait names, and concatenates phrases describing typical behaviors into a coherent instruction, for example: “Generate a detailed personality prompt for a brave knight who fights dragons and protects villagers. Emphasize courage, protection of others, and heroic behavior.”
The output of this step is a composed input sentence that incorporates the structured information in a form that conditions the generative AI model.

### Step 9:

The server uses a generative AI interface module to call a generative AI model and obtain a prompt sentence as a personality prompt.
The input to this step is the composed input sentence, along with generation parameters such as maximum token length, temperature, and sampling strategy.
The server tokenizes the input sentence into model tokens, passes the tokens as input to a trained transformer-based language model, and executes forward propagation through multiple attention and feed-forward layers to compute probability distributions over output tokens. The server then selects output tokens step-by-step according to the specified sampling method.
The output of this step is a generated text string that describes the character in the second person as a set of instructions and reactions, for example: “You are a brave knight sworn to protect the innocent. You stand fearlessly before dragons, shield villagers from danger, and never abandon those in need.”

### Step 10:

The server uses the prompt generation control module to enforce constraints on the expression format and length of the generated prompt sentence.
The input to this step is the raw generated text string produced by the generative AI model.
The server analyzes pronoun usage and sentence structure to confirm that the text is directed to “you,” checks the number of tokens or characters against length constraints, and, if necessary, performs rule-based rewriting or truncation to adjust any third-person forms to second-person and to remove excessive or redundant segments.
The output of this step is a normalized prompt sentence that conforms to predefined style requirements and length limits, suitable for reuse as a control instruction.

### Step 11:

The server transmits the generated prompt sentence to the terminal and enables user customization.
The input to this step is the finalized prompt sentence and the session identifier.
The server includes the prompt sentence in a response payload and sends it via a communication interface, and the terminal receives the payload, parses it, and displays the prompt sentence in an editable text field. The user sees, for example, “You are an intelligent detective who approaches every case with calm, methodical logic. You rely on keen observation, subtle clues, and rigorous deduction to uncover the truth.”
The output of this step is that the terminal holds and displays the prompt sentence, and the user is able to edit, extend, or annotate the sentence through direct interaction.

### Step 12:

The user reviews the displayed prompt sentence on the terminal and performs customization if necessary.
The input to this step is the prompt sentence presented in the terminal interface.
The user reads the text, decides whether it matches the intended personality and behaviors, and may edit words or add new clauses, such as “You also encourage your allies with inspiring words during battle” or “You remain emotionally detached when interrogating suspects.”
The output of this step is a modified prompt sentence, created by the user, that is still presented as a personality prompt but reflects user-specific preferences.

### Step 13:

The terminal sends the customized prompt sentence back to the server for storage and potential reuse with other generative AI models.
The input to this step is the user-modified prompt sentence and any associated metadata, such as tags or intended use.
The terminal packages the customized text into a request and transmits it to the server; the server receives the request and associates the customized prompt with the stored structured data and session identifier.
The output of this step is a stored customized prompt sentence that can be retrieved and output as a standardized prompt sentence for downstream systems.

### Step 14:

The server uses an emotional state estimation module to estimate an emotional state of the user from interaction data and terminal state information.
The input to this step is a collection of operation logs and state values, including numbers of edits, numbers of regeneration requests, time intervals between operations, and display events supplied by the terminal.
The server converts these logs into numerical features, feeds the features into a trained classifier or applies rule-based thresholds, and calculates a label or score representing a likely emotional state, such as “satisfied” or “frustrated.”
The output of this step is an estimated emotional state associated with the current session.

### Step 15:

The server adjusts generation conditions or prompt content based on the estimated emotional state and prepares for subsequent prompt generation.
The input to this step is the estimated emotional state and the current structured data or prompt sentence.
The server modifies generation parameters, such as increasing maximum length when the user appears dissatisfied, simplifying template structure when confusion is inferred, or changing the level of detail requested from the generative AI model. The server may also add guidance text to the input sentence, such as “Make the description more concise and easy to understand.”
The output of this step is an updated set of model parameters or input sentences that influence the next invocation of the generative AI model, thereby tailoring future prompt sentences to the user's state.

### Step 16:

The user optionally uses the finalized or customized prompt sentence as an input to another generative AI model via the same terminal.
The input to this step is the displayed prompt sentence, such as “You are a brave knight sworn to protect the innocent. You stand fearlessly before dragons, shield villagers from danger, and never abandon those in need.”
The user copies the sentence, pastes it into a separate application or dialogue box connected to a different generative AI model, and adds a specific request such as “Using this personality, write a scene where the knight confronts a dragon attacking a mountain village at night.”
The output of this step is a compound prompt used to control another generative AI model, in which the personality prompt produced by the server functions as a structured control signal that shapes the content generated by the external model.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content generation systems that utilize generative AI models typically rely on static prompts and predetermined branching logic. In such systems, a server receives a simple text prompt or a limited set of user selections, and a generative AI model produces a story or dialogue in a single batch. These approaches suffer from several technical limitations. First, they do not provide a structured mechanism for decomposing user input into machine-interpretable attribute information for characters and do not systematically construct personality prompts that can be reused as behavioral constraints in subsequent generation. Second, the systems generally lack a closed feedback loop between user editing on a terminal and the server-side generative process, and therefore cannot efficiently refine or specialize the behavior of a generative AI model for a given interactive session. Third, conventional systems often deliver generated content as a monolithic block, which prevents real-time streaming presentation and can increase latency and resource usage on both server and terminal. Fourth, user state information such as emotional state or behavior history is typically not integrated into the generative pipeline as a dynamic control signal, so the system cannot adapt story generation conditions on a fine-grained, per-segment basis. As a result, such systems provide limited interactivity, reduced responsiveness, and suboptimal utilization of computational resources in the server-terminal architecture.

There is therefore a need for an improved computer-implemented technique that structures the interaction between the user terminal and the generative AI model through explicit character attribute information and personality prompts, that supports user customization of these personality prompts at the terminal, that performs server-side story generation in a segmented and streamable manner, and that dynamically adjusts generation conditions based on user emotional state or behavior history. Such a technique should improve the functioning of the server system itself by organizing data flows (attribute acquisition, prompt construction, incremental story generation, and streaming transmission), reducing perceived latency, and enabling more adaptive and controllable operation of the generative AI model within a real-time content delivery environment.

The specific processing by the specific processing unit 290 of the data processing device 12 in Application Example 1 is realized by the following means.

The present invention provides a server comprising a processor configured to acquire, via a communication unit, attribute information related to a character and user-related information received from a user terminal, to automatically generate, based on the acquired attribute information, a prompt sentence including a personality prompt that instructs specific actions and reactions of the character by performing natural language processing using a generative AI model, to enable the automatically generated personality prompt to be customized by allowing a user to edit or add to the personality prompt via a user interface on the user terminal and to receive, from the user terminal, a customized personality prompt, to automatically generate, based on the customized personality prompt and the attribute information, a story corresponding to characteristics of the character by performing natural language processing using the generative AI model, to divide the generated story into a plurality of text segments and sequentially transmit the text segments in real time to the user terminal using a network communication method, to acquire a user emotional state or user behavior history and dynamically adjust generation conditions for the personality prompt or the story according to the acquired emotional state or behavior history, and, when different attribute information is selected by the user, to automatically regenerate the personality prompt and the story based on the different attribute information and present the regenerated story to the user terminal as a different story development. This enables a computer-implemented content generation system in which the server coordinates structured character attribute acquisition, personality prompt construction, user-driven customization, segmented and streamable story generation, and adaptive control based on user state, thereby improving the technical operation of the generative AI model, reducing response latency, enhancing resource utilization, and providing more responsive and controllable real-time interactive story experiences.

The term “system” refers to a combination of hardware components and software components that cooperate to execute the processing described in the claims, including at least one server-side device and one or more user terminals connected via a communication network.

The term “processor” refers to one or more hardware processing units, such as a central processing unit or a graphics processing unit, configured to execute instructions stored in a memory to implement the functions described in the claims.

The term “communication unit” refers to hardware and software components, such as a network interface controller and communication protocols, that enable data transmission and reception between the processor and external devices over a wired or wireless network.

The term “user terminal” refers to an information processing device operated by a user, such as a portable terminal, a head-mounted display, or a general-purpose computing device, that communicates with the server and presents information to the user.

The term “attribute information” refers to structured information representing properties of a character, including at least a character type, personality traits, or contextual settings used as input conditions for content generation.

The term “user-related information” refers to information associated with a user, including but not limited to user identifiers, usage history, behavior history, or emotional state information, which is used by the processor to control content generation.

The term “character” refers to an entity appearing in a generated story, such as a fictional person or agent, whose behavior, reactions, and dialogue are determined based on attribute information and a personality prompt.

The term “prompt sentence” refers to a text sequence provided as input to a generative AI model, the text sequence including instructions, constraints, or descriptive information that conditions the output of the generative AI model.

The term “personality prompt” refers to a prompt sentence or a portion thereof that describes or instructs specific behavioral tendencies, reactions, speaking styles, or decision-making patterns of a character, and that is used as a constraint when generating content.

The term “generative AI model” refers to a machine learning model, such as a large language model, configured to generate text by predicting sequences of output tokens based on input prompt sentences.

The term “natural language processing” refers to processing performed by the generative AI model or other software to interpret or generate human-readable text based on input data expressed in natural language.

The term “customized personality prompt” refers to a personality prompt that has been edited, supplemented, or otherwise modified by a user via a user interface on the user terminal, and that is transmitted to the server for use in subsequent content generation.

The term “story” refers to a sequence of one or more text segments generated by the generative AI model, the sequence describing events, actions, dialogues, or thoughts involving at least one character.

The term “text segment” refers to a part of a story, such as a sentence, a paragraph, or a group of sentences, that is handled as a unit for transmission, display, or processing.

The term “real time” refers to processing and transmission performed with latency sufficiently low that the user perceives that generated text segments are presented substantially without delay as they are produced by the server.

The term “network communication method” refers to a protocol or mechanism for transmitting data over a communication network, including but not limited to HTTP, WebSocket, or other streaming-capable protocols.

The term “user interface” refers to software components and display elements provided on the user terminal that allow the user to view information and input operations, including text input fields, buttons, and menus.

The term “user emotional state” refers to information indicative of a user's emotional condition, which may be derived from explicit user input, sensor data, interaction patterns, or other computational estimations, and used to control content generation.

The term “user behavior history” refers to recorded information about past user interactions with the system, including character selections, editing actions, reading patterns, or other usage logs.

The term “generation conditions” refers to parameters or constraints applied when the generative AI model generates content, including but not limited to prompt content, temperature, length constraints, narrative style, and scene settings.

The term “scene setting” refers to information specifying contextual elements of a story, such as location, time, atmosphere, or situation, which is used in a prompt sentence to condition the generative AI model.

The term “narrative style” refers to constraints on how a story is expressed, such as point of view, tense, formality level, or genre, which are included in a prompt sentence.

The term “length constraint” refers to a limitation on the amount of generated content, such as maximum token length, number of words, or number of paragraphs, that is provided to the generative AI model as part of a prompt sentence or parameter setting.

The term “candidate character attribute information” refers to a set of proposed attribute information items for characters that are generated or selected by the processor and presented to the user as options or suggestions.

The term “example personality prompt” refers to a sample personality prompt generated or stored by the system, which is presented to the user as a reference when designing a new personality prompt.

The term “example story development” refers to a sample portion of a story, including possible plot progressions or scene variations, that is generated or stored by the system and presented to the user as reference information.

The term “different story development” refers to a story whose progression, events, or character behavior differs from a previous story, the difference resulting from changes in attribute information, personality prompts, or generation conditions.

In one embodiment, a server cooperates with one or more terminals operated by a user to implement the claimed system. The server includes at least one central processing unit, at least one graphics processing unit, a main memory, a non-volatile storage device, and a network interface. The server executes application software such as an HTTP application framework (for example, a web application framework running on a general-purpose operating system), a database management system (for example, a relational database), and a generative AI model engine implemented as a neural network inference library. The terminal includes a processing unit, a display device, an input device such as a touch panel or controller, a local memory, and a communication interface for communicating with the server over a packet-based network.

The server stores, in the non-volatile storage device, program modules including a communication module, a session management module, a character attribute management module, a prompt construction module, a generative AI model interface module, a story segmentation and streaming module, a user state analysis module, and a user interface support module. The server loads these modules into the main memory and causes the processor to execute them. The terminal stores, in a local memory, an application that provides a user interface for character selection, prompt editing, and story display, and causes a processor in the terminal to execute the application.

The server implements the generative AI model as a trained large-scale neural network, such as a transformer-based language model having multiple attention layers, feed-forward layers, and embedding layers. The server stores, in the non-volatile storage device, model parameters including weight matrices and bias vectors for each layer. The server pre-trains the neural network on a large corpus of text data using a supervised learning method such as next-token prediction, and uses an error function such as cross-entropy loss to compute prediction errors.

The server updates model parameters during training using an optimization algorithm such as stochastic gradient descent or a variant thereof (for example, an adaptive learning rate optimizer), by back-propagating gradients through the multiple network layers. The server optionally performs data augmentation during training by randomly masking tokens, shuffling sentence fragments within defined constraints, or injecting synthetic attribute labels to improve robustness of the model to variations in prompt sentences.

The server uses a specific internal data structure to represent character attribute information. For example, the server represents character type, personality traits, and context tags as key-value pairs in a structured record stored in the database. The server associates each character attribute with a normalized identifier and a weight indicating its relative importance. The server uses this explicit structured representation to construct a deterministic portion of a prompt sentence, so that the generative AI model receives consistent and machine-interpretable conditioning information. This differs from simply passing user-supplied free-form text to the model, and contributes to improved reproducibility and controllability of model outputs.

The server constructs a personality prompt by combining a fixed instruction template with the stored character attribute record. The server concatenates text fragments in a defined order, such that attribute fields always appear in a consistent sequence. For example, the server uses an instruction template of the following form as a base:
“You are a system that creates a personality description for a story character.
Character type: [character_type]
Traits: [trait_1], [trait_2], etc.
Generate a detailed personality prompt that describes the character's typical actions, reactions, and speaking style. Use clear instructions that another AI can follow.”

The server replaces bracketed placeholders with attribute values stored in the character attribute record. The server then passes this constructed prompt sentence to the generative AI model. By using this structured construction process, the server reduces ambiguity in the conditioning of the generative AI model, thereby improving the consistency and accuracy of generated personality prompts across sessions and users.

The server, when performing inference with the generative AI model, processes input prompt sentences by tokenizing the text into subword units using a predefined tokenizer. The server maps each token into a high-dimensional vector using an embedding matrix stored in the model parameters. The server then passes the sequence of vectors through multiple transformer layers that compute self-attention scores and contextually enriched representations. The server applies position encodings, layer normalization, and nonlinear activation functions according to the architecture specification. The server finally computes output token probabilities using a softmax layer. This series of computations is performed on a graphics processing unit to accelerate matrix multiplications and attention operations. By using GPU-accelerated transformer inference, the server reduces latency and enables real-time streaming of generated text segments to the terminal.

The server applies specific generation conditions to the generative AI model, such as a temperature parameter controlling randomness of token sampling, a top-k or top-p filtering parameter limiting the candidate tokens at each step, and a maximum token count limiting the length of generated sequences. The server dynamically adjusts these parameters based on user emotional state or behavior history. For example, when a user exhibits a preference for concise stories, the server reduces the maximum token count and increases the segment frequency, thereby shortening each generated segment while increasing the update rate. When a user exhibits repeated selection of high-intensity scenarios, the server may adjust the scene setting portion of the prompt sentence to emphasize conflict or urgency.

The server constructs a story-generation prompt sentence by combining the customized personality prompt received from the terminal, scene setting information, narrative style constraints, and length constraints. For example, the server can use the following prompt sentence:
“You are a generative AI model that writes vivid, third-person fantasy stories.
Use the following personality prompt as strict behavioral rules:
[custom_personality_prompt]
Write the first scene of a story where the village is attacked at night.
Show the character's thoughts, dialogue, and actions that are consistent with the personality prompt. Limit the scene to about 1000 words.”

The server merges the customized personality prompt into this template and supplies the complete prompt sentence to the generative AI model. Because the server uses a fixed outer template, the generative AI model is constrained to always treat the personality prompt as a rule set, which improves alignment between user customization and generated character behavior.

The terminal displays the generated personality prompt in a text editing area using a GUI framework. The user edits textual content directly, adding details of internal conflicts, speech patterns, or reaction rules. The terminal captures all edits as a continuous text string and transmits the final version as a customized personality prompt to the server. The server stores this customized prompt as a separate field in the session record, which is then used as a conditioning component for subsequent story generation. This explicit separation between system-generated personality prompts and user-customized prompts allows the server to maintain a clear data lineage, making it possible to analyze which changes affect downstream model outputs, and to cache or reuse partial prompts across sessions for increased computation efficiency.

The server segments the generated story text into multiple text segments according to predetermined criteria. For example, the server detects sentence boundaries using punctuation and internal language model probabilities, or detects paragraph breaks using newline characters. The server maintains a sliding buffer of generated tokens and flushes the buffer to the terminal when the buffer reaches a target length or when a natural segment boundary is detected. This segmented streaming approach allows the server to reduce perceived latency and smooth network load, because the server does not need to wait for the entire story to be generated before transmitting content. Instead, the server transmits segments incrementally, and the terminal renders them as they arrive.

The terminal, upon receiving each text segment, appends the segment to a display area and optionally scrolls or highlights new content. The user perceives that the story unfolds in real time, even though the generative AI model continues to compute subsequent tokens on the server. This real-time rendering differs technically from conventional batch text generation, because the server and terminal coordinate a continuous stream of smaller data units, which reduces memory spikes on the terminal and enables adaptive control by the server. For example, the server can modify generation conditions for later segments if the user's emotional state or reading behavior changes during the ongoing story, by adjusting temperature, length, or prompt components mid-stream.

The server analyzes user emotional state or behavior history using stored logs of interactions and, optionally, additional sensor data received from the terminal. The server may compute simple numeric features such as reading speed, frequency of pausing or skipping sections, or selection patterns of character attributes. The server may also use a separate, smaller neural network model to classify coarse emotional categories based on textual feedback entered by the user or based on reactions collected through the interface. The server then uses these numeric features as control signals to adjust generation conditions or to select different prompt templates. This processing goes beyond human manual adjustment, because the server can update generation parameters at a per-segment time scale and can systematically react to patterns that would not be easily recognized by a human.

The server implements an internal rule set that constrains how personality prompts and story prompts are built. For example, the server enforces a rule that a personality prompt must always include at least one instruction about how the character reacts to danger, one instruction about how the character speaks, and one instruction about the character's internal motivation. If the generative AI model returns a personality prompt lacking one of these components, the server detects the omission using pattern matching and automatically issues a corrective prompt or appends a standard fallback instruction. This rule-based correction provides a non-conventional post-processing step that increases reliability of generated prompts and reduces the need for manual editing by the user, while still allowing customization.

The server, in another embodiment, maintains multiple generative AI models with different sizes or capabilities. The server selects a smaller, faster model to generate preliminary candidate personality prompts and uses a larger, more accurate model only when a user confirms or refines a candidate. This hierarchical model selection reduces average inference cost and improves response time without substantially degrading quality, because the system leverages the larger model only when necessary. The server may further cache embeddings or internal representations of character attributes so that repeated requests for similar attributes reuse previously computed vectors, thereby reducing redundant computation within the generative AI model pipeline.

The server improves data management by storing structured records of character attributes, personality prompts, and story segments in a relational schema. The server uses indexed queries to retrieve prior sessions with similar attributes and can propose candidate character attributes or example personality prompts as reference information. For example, the server may generate the following example personality prompt and present it to the user:
“The character is a brave knight who always stands between danger and the innocent. He speaks in short, determined sentences, never begs for mercy, and always looks for a way to protect others, even at great personal risk.”

The server may also generate multiple alternative prompts that vary specific aspects such as formality of speech or risk tolerance. By organizing such reference information in keyed tables and retrieving them using index-based searches, the server reduces lookup latency and supports interactive exploration without re-computing all examples from scratch.

The server improves communication efficiency by tailoring segment sizes and update intervals based on network conditions. For example, when the round-trip time between server and terminal increases, the server increases segment length to reduce protocol overhead and thereby mitigates throughput loss. Conversely, when network conditions are favorable, the server uses shorter segments to enhance the perception of responsiveness. The server monitors transmission success and adjusts segment size parameters stored in memory. This adaptive streaming strategy is facilitated by the segmented text representation and the explicit separation between sentence-level generation and transport-level chunking.

The server, by combining structured attribute management, rule-driven prompt construction, transformer-based generative AI inference, segment-based streaming, and adaptive parameter control based on user state, improves the functioning of the computer system as a whole. Specifically, the server reduces generation latency by offloading matrix operations to the graphics processing unit and by streaming segments as soon as partial outputs become available. The server reduces error rates in character behavior consistency by enforcing structural rules and using explicit personality prompts as constraints. The server improves memory utilization on both server and terminal by handling stories as incremental segments rather than monolithic strings. The server also structures data flows in a way that allows efficient caching, reuse, and analysis of intermediate representations, which is not achievable by simple manual authoring or straightforward automation of human tasks.

In a further embodiment, the terminal can be a head-mounted display that overlays the generated story text or associated imagery in an immersive environment. The server may then additionally output timing markers or scene tags attached to text segments. The terminal uses these markers to synchronize rendering of visual or audio elements with story progression. Such integration between generated textual content and device-level control (for example, controlling frame updates or audio playback) provides a concrete use of the generative AI model in controlling the behavior of a computing device, and therefore links the abstract model computations to specific machine-level operations.

In yet another embodiment, the server may use different neural network architectures such as a mixture-of-experts transformer, where specific experts are activated based on character attribute vectors. The server computes a routing decision by projecting attribute vectors into a lower-dimensional space and selecting experts using a learned gating function. This non-uniform expert selection further increases computational efficiency, because only a subset of experts is executed for a given character, and also improves stylistic consistency, because attributes that map to similar regions in the attribute space share specialized experts.

This architecture, combined with the structured attribute representation and personality prompt templates, enables the server to scale to a large variety of character types without linearly increasing inference cost.

Through these embodiments, the server, the terminal, and the user cooperate to implement the claimed system in a manner that goes beyond generic data acquisition and display. The server structures internal data, enforces non-conventional processing rules, and uses specific neural network architectures and streaming mechanisms to achieve technical effects such as faster response, improved consistency and controllability of generated content, reduced communication overhead, and more efficient use of computational resources.

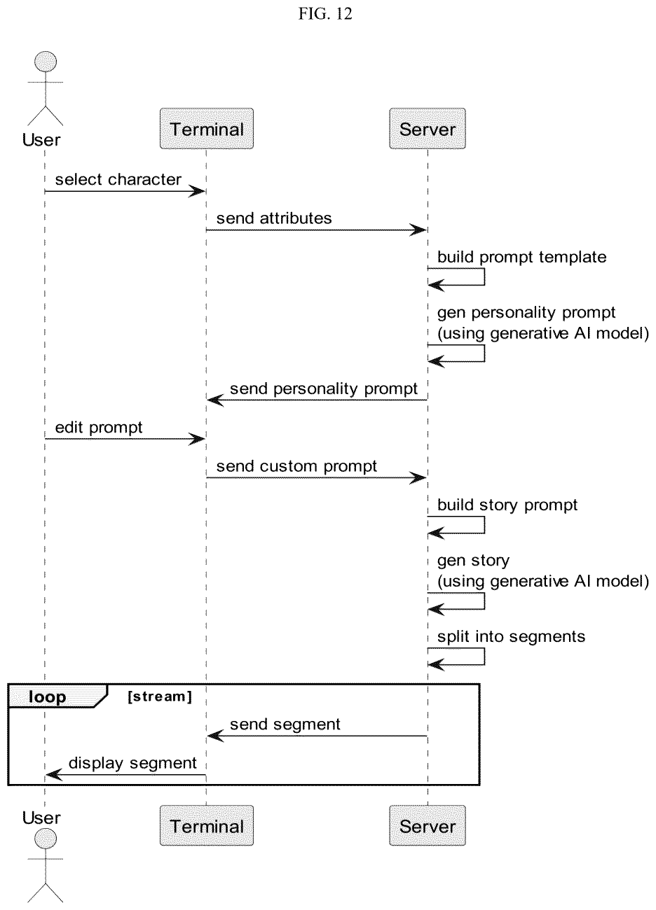

The following describes the processing flow using FIG. 12.

### Step 1:

The terminal presents a character selection screen to the user.
The terminal displays, on a display device, a list of character types and traits using a graphical user interface.
Input: internally stored character types and traits.
Output: a rendered selection UI on the terminal.
The terminal reads predefined character attribute data from local storage or from a previous configuration response from the server, and renders selectable elements such as buttons, lists, and check boxes. The terminal maps each selectable element to an internal attribute identifier.

### Step 2:

The user selects character attributes on the terminal.
The user operates an input device such as a touch panel, mouse, or controller to choose one or more character types and traits.
Input: the rendered selection UI from the terminal.
Output: selected character attribute values in the terminal's working memory.
The terminal detects input events (for example, tap or click events), updates the selected state of each UI component, and stores the selected attributes as structured data in memory, such as a record containing a character type field and a list of trait fields.

### Step 3:

The terminal transmits the selected attribute information to the server.
The terminal constructs a structured request message including the selected character attributes and a user session identifier.
Input: selected character attribute values stored in the terminal's memory.
Output: a network message containing attribute information sent to the server.
The terminal serializes the attribute record into a text format, attaches protocol headers (including content type and authentication data), and sends the message through a communication interface over a packet-based network to a server endpoint.

### Step 4:

The server receives and validates the attribute information.
The server accepts the incoming request via a network interface and parses the received message body.
Input: network message containing attribute information and session identifier.
Output: validated attribute record stored in server memory and optionally in a database.
The server decodes the message, checks that required fields such as character type and traits are present, verifies that each field meets type and length constraints, and discards or corrects invalid values. The server then writes the validated attributes to a session record in a database and to a transient in-memory structure for immediate processing.

### Step 5:

The server constructs an initial personality prompt sentence template.
The server generates a base instruction text that describes how the generative AI model should create a personality description.
Input: validated character attribute record from the server memory.
Output: a partially constructed prompt sentence including attribute placeholders.
The server reads the character type and traits from the record and inserts them into predefined positions in a template. The server assembles lines such as “Character type: [character_type]” and “Traits: [trait_1], [trait_2]” to form a structured instruction text.

### Step 6:

The server generates a full personality prompt using the generative AI model.
The server submits the constructed prompt sentence to the generative AI model for natural language generation.
Input: the structured prompt sentence containing character type and traits.
Output: a generated personality prompt text describing typical actions, reactions, and speaking style.
The server tokenizes the input prompt, maps tokens to embedding vectors, and passes them through the layers of a neural network (such as multiple transformer blocks). The server computes attention scores, updates intermediate vectors, and computes output token probabilities. The server samples or selects tokens step by step according to parameters such as temperature and top-p, concatenates the resulting tokens into text, and forms the personality prompt.

### Step 7:

The server post-processes and stores the generated personality prompt.
The server refines the generated text to satisfy internal structural rules.
Input: raw generated personality prompt text from the generative AI model.
Output: a normalized personality prompt stored in association with the session record.
The server removes trailing whitespace, enforces maximum length limits, and checks that sections about reactions, speech style, and motivation are present. When required sections are missing, the server inserts fallback sentences from a rule library. The server then stores the normalized prompt text in the session data structure in memory and in the database.

### Step 8:

The server transmits the personality prompt to the terminal.
The server prepares a response message that contains the normalized personality prompt.
Input: normalized personality prompt and user session identifier on the server.
Output: a network response message sent to the terminal containing the personality prompt.
The server packages the prompt text into a response payload, sets appropriate protocol headers, and sends the message through the network interface to the terminal.

### Step 9:

The terminal displays the personality prompt for user customization.
The terminal receives the response and renders the prompt text in an editable view.
Input: network response containing the personality prompt.
Output: an on-screen text editing area populated with the personality prompt.
The terminal parses the message payload, stores the received text in memory, and binds the text to a graphical text editor widget. The terminal renders scroll bars, cursor, and editing controls, enabling direct text manipulation.

### Step 10:

The user customizes the personality prompt on the terminal.
The user edits, adds, or removes sentences from the displayed personality prompt.
Input: the displayed personality prompt in the terminal's editor.
Output: a customized personality prompt stored in the editor's internal buffer.
The terminal captures user keyboard input and editing gestures, applies operations such as insertion, deletion, and replacement to the text buffer, and continually updates the visual display. When the user confirms completion, the terminal freezes the current buffer as the customized personality prompt.

### Step 11:

The terminal sends the customized personality prompt back to the server.
The terminal prepares a new request that includes the customized prompt text and references the original attribute information.
Input: customized personality prompt text from the editor buffer.
Output: a network message containing the customized personality prompt sent to the server.
The terminal serializes the text into a payload, attaches the session identifier and a flag indicating customization completion, and transmits the message through the communication interface to the server.

### Step 12:

The server associates the customized personality prompt with the session.
The server updates session data structures with the user-edited prompt.
Input: message containing the customized personality prompt and session identifier.
Output: a session record updated with both original attributes and customized personality prompt.
The server parses the message, validates the text length and character set, and replaces or adds the customized prompt field in the corresponding session entry in memory and in the database.

### Step 13:

The server constructs a story-generation prompt sentence.
The server composes a new instruction text for the generative AI model to generate a story.
Input: character attribute record and customized personality prompt stored in the session.
Output: a detailed story-generation prompt sentence including scene setting, narrative style, and length constraints.
The server assembles an instruction such as:
“You are a generative AI model that writes vivid, third-person fantasy stories.

Use the following personality prompt as strict behavioral rules:
[custom_personality_prompt]
Write the first scene of a story where the village is attacked at night.
Show the character's thoughts, dialogue, and actions that are consistent with the personality prompt. Limit the scene to about 1000 words.”
The server merges the customized personality prompt into the template and stores the final text as the story-generation prompt.

### Step 14:

The server generates a story using the generative AI model.
The server executes the generative AI inference process with the story-generation prompt as input.
Input: the story-generation prompt sentence.
Output: a continuous story text describing events, thoughts, and dialogue.
The server tokenizes the prompt, processes the token sequence through the neural network layers, and at each step computes probabilities for the next token. The server selects tokens according to configured generation parameters and concatenates them to form a story string until reaching a defined stop condition such as maximum length or an end marker.

### Step 15:

The server segments the generated story into text segments.
The server divides the story text into smaller units suitable for streaming.
Input: full generated story text.
Output: an ordered list of text segments representing portions of the story.
The server scans the story string, identifies sentence and paragraph boundaries using punctuation and newline markers, and groups contiguous tokens into segments whose lengths fall within configured minimum and maximum thresholds. The server tags each segment with an index and timing data for transmission ordering.

### Step 16:

The server streams text segments to the terminal in real time.
The server transmits each segment to the terminal as soon as it is prepared.
Input: ordered list of text segments and network connection state.
Output: a sequence of network messages, each containing a text segment, sent to the terminal.
The server sends the first segment immediately, then iteratively sends subsequent segments either upon generation completion or according to a scheduling interval. The server monitors acknowledgment responses and adjusts segment size or pacing if network latency or errors are detected.

### Step 17:

The terminal receives and renders streaming story segments.
The terminal appends each segment to a story display area for the user.
Input: sequence of network messages containing story segments.
Output: a progressively updated on-screen story view.
The terminal parses each received message, extracts the segment text, and concatenates it to a local display buffer. The terminal re-renders the story view with the new content and scrolls automatically or highlights appended lines so that the user can follow the evolving story in real time.

### Step 18:

The server monitors user emotional state and behavior history.
The server collects and analyzes interaction data from the terminal to infer user state.
Input: usage logs from the terminal, including reading speed, pause events, and optional feedback signals.
Output: a set of numeric features and derived state indicators stored with the session.
The server processes timestamps and event sequences to compute statistics such as average time spent per segment, frequency of segment skipping, and repetition of certain character choices. The server optionally applies a classification model to map these features to coarse emotional categories and stores resulting scores in the session record.

### Step 19:

The server dynamically adjusts generation conditions based on user state.
The server modifies generative AI parameters and prompt components using the state indicators.
Input: numeric user state features and current generation settings.
Output: updated generation parameters and, optionally, updated prompt templates.
The server computes new values for temperature, maximum story length, and narrative intensity by applying predetermined rules or learned mappings to the extracted features. The server may also adjust subsequent scene settings in future prompt sentences (for example, by reducing conflict elements for users showing signs of stress), and records these adjustments for use in the next story generation cycle.

### Step 20:

The user selects different character attributes for a new story.
The user initiates a new character configuration on the terminal to experience a different storyline.
Input: the character selection UI displayed by the terminal and the user's decision to change character attributes.
Output: a new set of character attribute values selected on the terminal.
The terminal again captures selection inputs, updates internal attribute records, and presents confirmation options. When the user confirms, the terminal prepares to send the new attribute information to the server.

### Step 21:

The terminal transmits the new attribute information to the server for regeneration.
The terminal triggers a new content generation cycle with the updated attributes.
Input: newly selected character attribute values.
Output: a new attribute information message sent to the server.
The terminal serializes the new attribute data, attaches a reference to the existing session or creates a new session identifier, and sends the data to the server through the communication interface, thereby initiating regeneration of a new personality prompt and story corresponding to the newly selected character.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional prompt design systems for generative artificial intelligence models generally treat a prompt sentence as a static text artifact that is created once and then directly supplied to a generative artificial intelligence model. In such systems, a processor typically generates an initial prompt sentence or receives a manually created prompt sentence from a user, and then forwards that prompt sentence to a generative artificial intelligence model without providing an integrated, iterative environment for prompt refinement. As a result, the user must repeatedly engage in trial-and-error outside the system, manually adjust prompt sentences, and re-submit them, which is inefficient and highly dependent on individual experience and tacit knowledge.

Furthermore, known systems do not sufficiently integrate automatic analysis of customized prompt sentences with systematic feedback generation. Even when a generative artificial intelligence model is used, the model is commonly invoked only to generate output content (for example, text or images) rather than to generate structured feedback information that evaluates and improves the prompt sentence itself. Consequently, the processor does not effectively transform prompt sentences into higher-quality instructions based on explicit evaluation information and improvement proposals, and does not provide a technical mechanism for guiding the user through successive refinement cycles.

In addition, many systems treat user-specific contextual factors, such as a user's emotional state, as non-technical or external to the core processing pipeline. Conventional architectures generally do not acquire a time-varying emotional state of the user as input data, and do not dynamically adjust content or expression of a personality prompt sentence in response to such emotional data. This leads to rigid and context-insensitive behavior instructions for virtual entities, which can reduce the appropriateness and effectiveness of system responses, particularly in interactive or conversational applications that require ongoing adaptation. From a computer-technology perspective, these limitations manifest as: (i) an absence of an integrated pipeline in which a processor orchestrates acquisition, generation, customization, storage, and feedback-based refinement of prompt sentences using a generative artificial intelligence model; (ii) a lack of structured feedback information, including explicit evaluation and improvement proposals, which can be consumed by the processor to support iterative editing assistance; and (iii) the failure to technically incorporate emotional state data as a control signal that dynamically modifies prompt-generation behavior at runtime. This results in suboptimal utilization of computational resources of the generative artificial intelligence model, reduced reproducibility of high-quality prompts, and an increased cognitive burden on the user.

Accordingly, there is a need for an improved computer-implemented system in which a processor coordinates the use of a generative artificial intelligence model not only to generate initial prompt sentences, but also to analyze user-customized prompt sentences, to produce structured feedback information, and to support iterative refinement of prompt sentences, while additionally adjusting personality prompt sentences based on a time-varying emotional state of the user. Such a system should technically improve the way computers generate and refine instructions for generative artificial intelligence models, thereby enhancing efficiency, consistency, and adaptability of prompt engineering operations performed by the processor.

The specific processing by the specific processing unit 290 of the data processing device 12 in Example 2 is realized by the following means.

The present invention provides a server comprising a processor and at least one storage device, the processor being configured to execute computer-executable instructions to acquire information from a user through an interface of a terminal device, generate, based on the acquired information, an initial prompt sentence including a personality prompt sentence that instructs specific behavior or reaction by using a natural language processing technique and a generative artificial intelligence model, transmit the initial prompt sentence to the terminal device and cause the terminal device to display the initial prompt sentence so that the user can edit or add content to the initial prompt sentence via the interface, store, in the storage device, a customized prompt sentence edited or added by the user on the terminal device, input the customized prompt sentence to the generative artificial intelligence model and cause the generative artificial intelligence model to generate feedback information including evaluation information and improvement proposals with respect to the customized prompt sentence, transmit the feedback information to the terminal device so as to support refinement of the customized prompt sentence by enabling iterative adjustment of the customized prompt sentence on the basis of the feedback information, and acquire an emotional state of the user as time-varying information and dynamically adjust content or expression of the prompt sentence including the personality prompt sentence in accordance with the emotional state. This enables the processor to implement an integrated, computer-implemented pipeline for generation, storage, analysis, and iterative refinement of prompt sentences using the generative artificial intelligence model, to automatically produce structured feedback that guides user editing operations, and to adapt personality prompt sentences in real time to a changing emotional state of the user, thereby improving the technical process by which computing systems construct and update prompt instructions for generative artificial intelligence models.

The term “processor” refers to a hardware processing unit or a combination of hardware processing units, such as one or more central processing units or one or more graphical processing units, configured to execute computer-executable instructions.

The term “storage device” refers to any non-transitory computer-readable medium, such as a magnetic storage medium, an optical storage medium, a semiconductor memory, or a solid-state drive, configured to store data and computer-executable instructions.

The term “terminal device” refers to an information processing apparatus operated by a user, such as a portable information terminal, a desktop computing device, or a display-equipped communication device, that is capable of communicating with a server and presenting an interface to the user.

The term “interface” refers to a hardware and software combination, including input and output components, that enables exchange of information between a user and a terminal device or between devices, such as a graphical user interface, a command-line interface, or an application programming interface.

The term “information from a user” refers to any data input by a user through an interface, including natural language text, selection operations, parameter settings, or other user-generated data relevant to generation or refinement of a prompt sentence.

The term “prompt sentence” refers to text data including at least one natural language expression that is supplied as an instruction or condition to a generative artificial intelligence model in order to cause the model to generate output data.

The term “personality prompt sentence” refers to a type of prompt sentence that defines or constrains behavior, reaction, or characteristics of an artificial agent, virtual entity, or computational process, and that instructs the generative artificial intelligence model to respond in accordance with such defined behavior, reaction, or characteristics.

The term “initial prompt sentence” refers to a first version of a prompt sentence that is generated automatically by a processor based on acquired user information before any editing or addition by the user.

The term “customized prompt sentence” refers to a prompt sentence obtained by modifying, extending, or otherwise editing an initial prompt sentence through user operations via an interface of a terminal device.

The term “natural language processing technique” refers to any algorithm, model, or software procedure that processes human language text, including analysis, transformation, or generation of text, such as tokenization, parsing, semantic analysis, or language generation.

The term “generative artificial intelligence model” refers to a computational model trained on data to generate new data, including natural language text, images, audio, or other content, in response to input data, and including but not limited to models based on machine learning or neural networks.

The term “feedback information” refers to information generated by a generative artificial intelligence model or by a processor that evaluates or comments on a prompt sentence and includes at least one of evaluation information, improvement proposals, or guidance for modifying the prompt sentence.

The term “evaluation information” refers to data that assesses one or more aspects of a prompt sentence, such as clarity, specificity, consistency, or suitability for a target generative artificial intelligence model.

The term “improvement proposals” refers to suggested modifications to a prompt sentence, such as added details, rewritten phrasing, or alternative versions, intended to enhance performance or quality of output generated by a generative artificial intelligence model.

The term “guidance information” refers to feedback information presented to assist a user in devising or refining a prompt sentence, including candidates, patterns, examples, and explanations for prompt construction.

The term “personality settings” refers to parameterized descriptions of behavior, style, or attributes of an artificial agent or virtual entity, such as temperament, tone, domain expertise, or interaction style, that can be encoded within a personality prompt sentence.

The term “behavior instructions” refers to elements within a prompt sentence that specify how an artificial agent, virtual entity, or computational process should act or respond under given conditions.

The term “expression styles” refers to stylistic characteristics of text included in a prompt sentence, such as formality level, narrative voice, tone, or linguistic register.

The term “emotional state of the user” refers to data representing a user's affective condition, such as calmness, excitement, frustration, or other emotional attributes, which may be estimated from user input, sensor data, interaction history, or other measurable signals.

The term “time-varying information” refers to data whose value may change over time, such as an emotional state of a user sampled at different points, interaction context, or environment conditions that evolve during system operation.

The term “virtual target” refers to a non-physical entity treated as an object of control or interaction by a system, such as a virtual character, a simulated agent, or a logical role executed by a generative artificial intelligence model.

The term “iterative adjustment” refers to a process in which a prompt sentence is repeatedly modified, evaluated, and further modified based on feedback information until a desired quality or behavior is achieved.

The term “editing assistance” refers to functionality by which a processor supports user modification of a prompt sentence, including suggesting changes, supplying alternative wordings, highlighting issues, or automatically inserting recommended text.

The term “transmit” refers to causing data to be sent from one device or component to another via a communication network or communication interface.

The term “acquire” refers to obtaining data from a source, such as receiving input from a user, reading from a storage device, or receiving from another device over a network.

The term “dynamically adjust” refers to modifying a parameter, prompt sentence, or system behavior in response to changing input conditions during runtime, without requiring system restart or manual reconfiguration of the underlying program code.

In one embodiment, a server, a terminal, and a user cooperate to implement a system for generating, customizing, and refining a prompt sentence for a generative AI model, and for dynamically adjusting a personality prompt sentence based on an emotional state of the user. The server includes at least one processor and at least one storage device. The processor executes a plurality of software modules implementing natural language processing and generative modeling functions. The storage device stores program instructions, model parameters, and prompt data records.

The server uses general-purpose computing hardware, such as an x86-based or ARM-based server device equipped with one or more central processing units and, in some embodiments, one or more graphics processing units for accelerating neural network inference. The server runs an operating system such as a UNIX-like operating system. The server executes application software implemented, for example, in a scripting language runtime or a compiled language runtime, and uses a web server component as a communication front-end. The server uses a machine learning framework, such as a tensor-based numerical computation library, to load and execute a generative AI model implemented as a transformer-based neural network.

The generative AI model is, in one embodiment, a multi-layer transformer architecture including a plurality of self-attention layers, feed-forward layers, normalization layers, and embedding layers. The server stores model parameters as real-valued weight matrices and bias vectors in the storage device. The server causes the processor to perform inference by executing matrix multiplication, non-linear activation, and attention-weight computation operations on vectorized input tokens. The server initializes token embeddings using a learned embedding matrix and applies positional encoding to preserve token order. The server uses a cross-entropy loss function during pre-training of the model and an optimization algorithm such as stochastic gradient descent with adaptive learning rate (for example, an adaptive moment estimation algorithm) during training, although training may be performed in advance on a separate training system. The server optionally applies data augmentation during training by perturbing textual input sequences, such as synonym substitution, sentence reordering within allowed ranges, or dropout on tokens, in order to improve robustness to noisy user input.

The server stores a natural language processing module that performs tokenization, part-of-speech tagging, named-entity recognition, and syntactic dependency analysis on user input.

The server uses established libraries or custom implementations to convert raw character sequences into token sequences, attach linguistic tags, and produce intermediate structured representations. The server represents parsed user input as a structured data object including fields such as intent, domain, mood, and constraints. For example, when the user provides an input such as:
“Create a prompt sentence for a generative AI model describing a dark fantasy city at night.” the server encodes this as a set of abstract features: domain=“fantasy”, time=“night”, environment=“city”, mood=“dark”, and requested usage=“text-to-image prompt”. The server then uses these features as conditioning information for the generative AI model.

The terminal is, in one embodiment, a smartphone, a tablet, or a personal computer equipped with a display, input devices, and a network interface. The terminal runs a client application, such as a native mobile application or a web browser application, which presents a user interface for configuring and editing a prompt sentence. The terminal acquires user input through a graphical user interface element, such as a multiline text field, buttons, sliders, or selection lists. The terminal sends the acquired user information to the server via a communication network using a defined application-level protocol.

The user interacts with the terminal to specify a theme, desired style, and target generative AI model usage. The user, for example, enters a textual description:
“Theme: heroic fantasy battle. Please generate a detailed English prompt sentence.”

The terminal sends this text to the server. The server receives the text, normalizes character encoding, removes extraneous whitespace, and segments the text into linguistic units. The server then executes a rule-based component that maps specific lexical patterns and keywords to high-level attributes. For example, the server maps “heroic fantasy battle” to genre=“fantasy”, action type=“battle”, and tone=“heroic”.

The server uses these attributes as conditioning vectors for the transformer-based generative AI model. The server constructs an input sequence that concatenates a system instruction, such as:
“Generate one detailed English prompt sentence for a generative AI model. The sentence must describe the given theme clearly and visually.”
   with tokens representing the extracted attributes. The server then causes the generative AI model to perform forward propagation: the processor computes successive hidden representations through the transformer layers, determines attention weights over previous tokens based on learned query, key, and value matrices, and generates a probability distribution over the vocabulary for each next token. The server uses a decoding algorithm, such as top-k sampling or nucleus sampling, to select tokens and generate the initial prompt sentence.

For example, the server generates an initial prompt sentence such as:
“A dark fantasy city at night, with narrow cobblestone streets lit by flickering lanterns and mysterious shadows moving between tall, ancient towers.”

The server transmits this initial prompt sentence to the terminal. The terminal displays the initial prompt sentence in an editable text area. The user then customizes the sentence by inserting or replacing text, such as changing the above sentence to:
“A dark fantasy city at night, with narrow cobblestone streets lit by flickering lanterns, rain-soaked rooftops, and mysterious hooded figures moving between tall, ancient towers.”

The terminal maintains an internal data structure that associates the original initial prompt sentence, the current customized version, and timestamps. The terminal stores this data in a persistent storage system such as a local relational database or a document-style storage, and optionally synchronizes it with the server for backup and further processing.

The server receives the customized prompt sentence from the terminal and prepares it for feedback generation. The server constructs an analysis request in which the customized prompt sentence is embedded along with explicit evaluation criteria. The server, for example, forms a structured control message that specifies that the generative AI model should output: (i) comments on clarity, specificity, and suitability for the target generative AI model; and (ii) multiple improved versions of the prompt sentence with incremental refinements.

The server then performs a second inference pass of the generative AI model, but in this pass the model operates in an analysis-and-synthesis role. The server conditions the model using an instruction that defines the role of an “expert prompt engineer” and provides the customized prompt sentence as input content. The transformer architecture uses the input tokens and the instruction to compute an internal representation that reflects semantic and syntactic properties of the prompt sentence. Based on this representation, the model generates feedback information including natural-language comments and alternative prompt sentences.

For example, the server obtains feedback information such as:
“Comment: Specify a camera angle and clarify the weather conditions.
Suggested prompt 1: A dark fantasy city at night, seen from street level, with narrow cobblestone streets shining under heavy rain, flickering lanterns reflecting in puddles, and mysterious hooded figures slipping between tall, ancient towers.
Suggested prompt 2: A dark fantasy city at night viewed from above, rain-soaked rooftops glistening under moonlight, narrow alleys lit by scattered lanterns, and shadowy hooded figures moving silently below.”

The server transmits this feedback information to the terminal. The terminal displays the comments separately from the suggested prompt sentences, allowing the user to read the analysis and optionally replace or merge their current customized prompt sentence with one of the suggested versions. The user may accept one of the suggested prompts and further refine it. For example, the user may change:
“A dark fantasy city at night, seen from street level, with narrow cobblestone streets shining under heavy rain, flickering lanterns reflecting in puddles, and mysterious hooded figures slipping between tall, ancient towers.”

to:
“A dark fantasy city at night, seen from street level, with narrow cobblestone streets shining under heavy rain, flickering orange lanterns reflecting in puddles, and three mysterious hooded figures slipping between tall, ancient towers in the distance.”

The server, in one embodiment, also acquires an emotional state of the user as time-varying information. The terminal may infer the emotional state by analyzing input patterns, such as typing speed, error frequency, or interaction choices; by using sensors; or by receiving explicit self-reported mood labels from the user. The terminal transmits encoded emotional state information (for example, calm, frustrated, or excited) to the server. The server stores recent emotional state values in a time-series data structure, such as a ring buffer, and may compute a smoothed emotional state using a weighted moving average.

The server uses the emotional state as an additional conditioning signal when generating or modifying a personality prompt sentence. The server, for instance, selects different behavior instructions for a virtual character depending on whether the user is stressed or relaxed. If the user is frustrated, the server adjusts the personality prompt sentence to increase supportive and empathetic behavior, for example:
“Respond in a calm and reassuring manner, provide step-by-step explanations, and avoid using overly technical terms.”

If the user is relaxed and exploratory, the server may adjust the personality prompt sentence to encourage more creative or challenging interactions, such as:
“Respond with imaginative and detailed explanations, propose alternative ideas, and invite the user to explore different perspectives.”

The server embeds the adjusted personality prompt sentence into the overall prompt sentence provided to the generative AI model that will generate downstream content (for example, answers in a conversational agent or instructions to other models). By integrating the emotional state into the prompt generation pipeline, the server controls the behavior of the computational system itself, not merely the display of information, and thereby realizes a technical control loop that adapts model behavior at runtime.

The server improves computer technology by structuring prompt refinement as an iterative, model-assisted process that uses explicit evaluation and candidate generation in a controlled data flow. The server reduces the number of blind trial-and-error interactions required to obtain a high-quality prompt sentence by performing targeted analysis and refinement using the transformer-based model. The server thereby reduces overall network traffic and computation by making each interaction more informative: the user receives guidance that converges toward a suitable prompt sentence in fewer iterations. The server additionally improves storage efficiency by maintaining a versioned data structure of prompt sentences and associated feedback, which allows reuse of prior refined prompts and prevents redundant computations.

The server uses a non-conventional combination of rule-based analysis and neural inference.

The server applies deterministic rules to extract high-level attributes from user input and to construct structured evaluation requests. The transformer model then operates on these structured inputs to generate feedback. This hybrid architecture differs from a purely manual workflow or a simple one-pass generation system. The server exploits internal attention mechanisms of the transformer to weigh different parts of the user's prompt sentence according to learned semantic importance, which enables fine-grained evaluation that a conventional rule-only system cannot efficiently provide.

The server also uses specialized decoding rules when generating feedback. For example, the server enforces that feedback comments be output in a numbered list with each list item addressing a separate aspect of the prompt sentence, such as specificity, style, or constraints.

The server instructs the model to generate multiple candidate prompt sentences that differ in particular controlled dimensions, such as viewpoint, lighting, or level of detail, while preserving the core intent. This structured diversity improves exploration of the prompt space and helps the user identify an optimal configuration more quickly than in systems that produce a single alternative.

The server's use of a trained generative model to generate feedback about prompt quality, rather than content only, results in improved technical performance. The server effectively uses the model as an adaptive heuristic for search in the high-dimensional space of possible prompt sentences. The model's learned parameters, optimized using large-scale text corpora and error functions, encode generalizable knowledge about which textual patterns yield more reliable responses from generative AI models. The server harnesses this encoded knowledge to automatically steer the editing process, thereby reducing user errors, improving the precision and consistency of prompts, and enhancing throughput of the overall system.

In another embodiment, the server implements multiple generative AI models with different capacities or domains. The server may use a compact model to perform rapid preliminary analysis and a larger model to produce detailed feedback only when necessary. By routing requests selectively, the server reduces computation time and energy usage while maintaining high feedback quality for complex prompts. The server may also cache feedback results associated with specific prompt features, enabling reuse of previously computed feedback for similar prompts, which further reduces redundant processing and communication overhead.

In yet another embodiment, the terminal pre-processes user edits before sending them to the server. The terminal computes a diff between the previous and current versions of the customized prompt sentence and transmits only the differences. The server then reconstructs the full current version by applying the diff to the stored previous version. This technique reduces data transfer volume across the network and allows the server to focus model analysis on the changed portions of the prompt sentence. Because the transformer model's attention mechanism can be biased toward tokens marked as changed, the server can achieve more efficient and targeted inference, thereby improving response latency.

The described system therefore is not limited to a mere automation of human editing tasks but provides a specific technical architecture in which the server, the terminal, and the user cooperate with a transformer-based generative AI model, structured data representations, and rule-based components. The server controls data flow and model behavior in a non-conventional manner, using emotional state signals and explicit evaluation structures to adaptively generate, refine, and personalize prompt sentences for generative AI models. This integrated design yields technical effects including more efficient utilization of computational resources, improved accuracy and consistency of generated prompts, reduced communication overhead, and enhanced responsiveness of interactive applications.

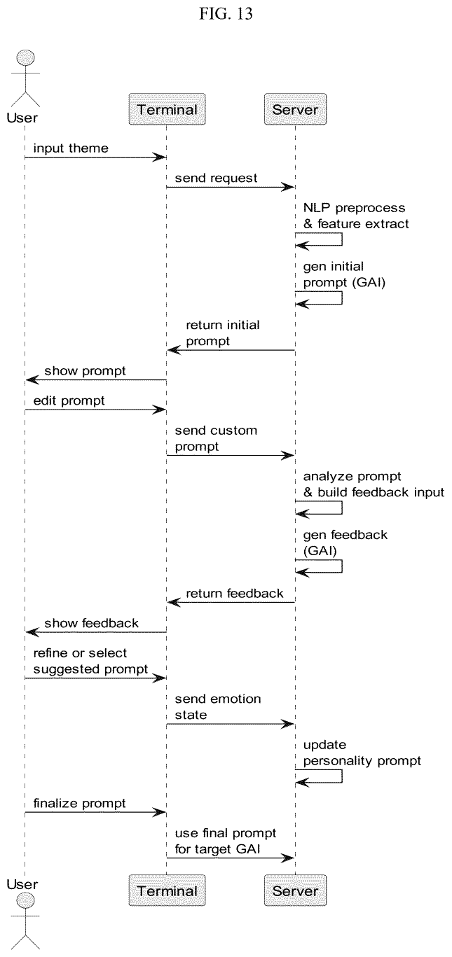

The following describes the processing flow using FIG. 13.

### Step 1:

The terminal displays an input interface and acquires initial user information.
The terminal presents a text input field, selection controls, and optional sliders that allow the user to specify a theme, desired style, and target use case for a generative AI model. The user inputs natural language text such as “Create a prompt sentence for a generative AI model describing a dark fantasy city at night” and optionally selects parameters such as “text-to-image” or “conversation style.”
Input: raw user text and parameter selections.
Output: a structured request object stored in the terminal's memory (for example, containing fields for theme, keywords, usage, and language), which the terminal prepares for transmission to the server.

### Step 2:

The terminal transmits the structured user request to the server.
The terminal serializes the structured request object into a message format and sends it over a communication network using a defined protocol to a designated endpoint on the server. The terminal waits for a response while optionally indicating progress to the user.
Input: structured user request object created in Step 1.
Output: a network message containing the structured user request, which is delivered to the server's communication interface.

### Step 3:

The server receives the user request and performs natural language preprocessing.
The server parses the network message, validates the structure, and extracts fields such as theme and keywords. The server normalizes the text by applying character encoding normalization, lowercasing where appropriate, and trimming whitespace. The server uses a natural language processing module to tokenize the theme text, perform part-of-speech tagging, and extract key concepts.
Input: structured user request from the terminal.
Output: a normalized and tokenized representation of the user's theme and parameters, including extracted attributes such as genre, mood, time, and location.

### Step 4:

The server converts the preprocessed user information into a model conditioning representation.
The server maps the extracted attributes to numerical feature vectors or symbolic tags that can be consumed by the generative AI model. For example, the server maps “dark fantasy city at night” to attributes such as genre=fantasy, mood=dark, environment=city, and time=night, and encodes these attributes as vectors or tokens. The server constructs an input sequence that combines a system instruction (for example, “Generate one detailed English prompt sentence for a generative AI model”) with the encoded attributes.
Input: normalized and tokenized user text and extracted attributes.
Output: a combined model input structure that includes instruction tokens and attribute encodings ready for input to the generative AI model.

### Step 5:

The server generates an initial prompt sentence using the generative AI model.
The server loads a trained transformer-based generative AI model into memory and passes the combined model input structure to the model's inference routine. The server causes the processor to execute matrix multiplications, attention-weight calculations, and non-linear activations to propagate information through the transformer layers. The server uses a decoding algorithm such as top-k or nucleus sampling to select the most probable or suitable next tokens in sequence, until forming a complete sentence. For example, the server may obtain the sentence: “A dark fantasy city at night, with narrow cobblestone streets lit by flickering lanterns and mysterious shadows moving between tall, ancient towers.”
Input: combined model input structure from Step 4.
Output: an initial prompt sentence as a human-readable string, representing an automatically generated instruction for a generative AI model.

### Step 6:

The server returns the initial prompt sentence to the terminal.
The server wraps the initial prompt sentence into a response structure and sends it over the communication network back to the terminal. The server logs the interaction for later analysis or reuse.
Input: initial prompt sentence produced in Step 5.
Output: a server response message containing the initial prompt sentence, delivered to the terminal.

### Step 7:

The terminal displays the initial prompt sentence and enables user customization.
The terminal receives the server response, extracts the initial prompt sentence, and renders it in an editable text field on the display. The user reviews the sentence and modifies it according to personal preferences. For example, the user changes the sentence to: “A dark fantasy city at night, with narrow cobblestone streets lit by flickering lanterns, rain-soaked rooftops, and mysterious hooded figures moving between tall, ancient towers.” The terminal updates the displayed text as the user types.
Input: initial prompt sentence from the server.
Output: a customized prompt sentence maintained in the terminal's local data structure and visually presented to the user.

### Step 8:

The terminal stores the customized prompt sentence and prepares it for feedback processing.
The terminal captures the final version of the customized prompt sentence when the user indicates completion, for example by pressing a “Save & Get Feedback” control. The terminal associates the customized prompt sentence with metadata such as timestamp, original initial prompt sentence, and usage type. The terminal stores this data in a persistent storage component, such as a local database or memory-backed file. The terminal then constructs a new request structure that includes the customized prompt sentence and metadata to request feedback.
Input: customized prompt sentence and user confirmation signal.
Output: a stored prompt record on the terminal and a structured feedback-request object ready for transmission to the server.

### Step 9:

The terminal transmits the customized prompt sentence to the server for feedback generation.
The terminal serializes the feedback-request object and sends it to the server using the communication protocol. The terminal may display a loading indicator while waiting for feedback.
Input: feedback-request object containing the customized prompt sentence and metadata.
Output: a network message conveying the customized prompt sentence to the server's feedback endpoint.

### Step 10:

The server analyzes the customized prompt sentence and constructs an analysis input for the generative AI model.
The server receives the customized prompt sentence, performs normalization and tokenization, and detects structural elements such as clauses, descriptive phrases, and constraints. The server builds an analysis context that specifies evaluation criteria such as clarity, specificity, and suitability for a target generative AI model, and formulates an instruction for the model to generate comments and improved variants.
Input: customized prompt sentence and associated metadata from the terminal.
Output: an analysis input structure that includes an instruction (for example, “Evaluate this prompt sentence and suggest improvements”) and the tokenized customized prompt sentence, ready to be provided to the generative AI model.

### Step 11:

The server generates feedback information using the generative AI model.
The server passes the analysis input structure to the generative AI model. The model processes the instruction and the customized prompt sentence through its transformer layers, internally computing attention distributions that focus on potentially ambiguous or underspecified parts of the sentence. The server decodes the model's output to obtain natural-language comments and multiple alternative prompt sentences that refine viewpoint, lighting, or level of detail. For example, the server may obtain comments such as “Specify a camera angle and clarify the weather conditions” and suggested prompts such as “A dark fantasy city at night, seen from street level, with narrow cobblestone streets shining under heavy rain, flickering lanterns reflecting in puddles, and mysterious hooded figures slipping between tall, ancient towers.”
Input: analysis input structure from Step 10.
Output: structured feedback information containing comments and suggested improved prompt sentences.

### Step 12:

The server returns the feedback information to the terminal.
The server organizes the feedback information into separate sections for comments and suggested prompts and sends this organized structure to the terminal via the communication network. The server may tag each comment and suggestion with identifiers or categories (for example, “clarity,” “style,” or “constraints”) to assist user interpretation.
Input: feedback information generated in Step 11.
Output: a feedback response message containing categorized comments and suggested prompt sentences, transmitted to the terminal.

### Step 13:

The terminal presents the feedback and supports iterative adjustment of the prompt sentence.
The terminal receives the feedback response, parses the comments and suggested prompts, and displays them in distinct user interface components, such as a comment list and a selectable list of alternative prompts. The user reviews the comments and selects one of the suggested prompts as a new base or continues editing the existing customized prompt sentence. The terminal updates the text field with the user's selection or edits, enabling iterative refinement based on the feedback.
Input: feedback response message from the server and current customized prompt sentence.
Output: an updated prompt sentence in the terminal's editor and a refreshed display that reflects comments and/or newly selected suggestions.

### Step 14:

The terminal acquires and transmits emotional state information of the user.
The terminal monitors interaction patterns such as typing speed, correction frequency, or explicit mood settings selected by the user, and derives an emotional state label such as calm, frustrated, or excited. The terminal encodes the emotional state as a simple label or numerical feature vector and sends this emotional state information to the server together with or separately from the latest prompt data.
Input: interaction signals or explicit mood input from the user.
Output: an emotional state representation transmitted to the server as time-varying user context data.

### Step 15:

The server dynamically adjusts a personality prompt sentence based on the emotional state.
The server receives the emotional state information and updates a time-series record of emotional states for the user, optionally applying smoothing or filtering. The server then selects or modifies a personality prompt sentence used to instruct the generative AI model, aligning the tone and behavior instructions with the current emotional state. For example, when the user is frustrated, the server modifies the personality prompt sentence to require calm and supportive responses; when the user is relaxed, the server enables more exploratory or challenging behavior. The server incorporates this adjusted personality prompt sentence into subsequent prompt sentences that are provided to the generative AI model for generating content.
Input: emotional state information from the terminal and existing personality prompt template.
Output: an updated personality prompt sentence that is integrated into the prompt sentence used for further generative AI model interactions.

### Step 16:

The user continues iterative refinement or finalizes the prompt sentence for downstream use.
The user, after reviewing feedback and any adjustments stemming from the emotional state-based personality prompt, may iteratively repeat editing, saving, and requesting feedback, or may decide that the current prompt sentence is satisfactory. The terminal then marks the prompt sentence as final and may allow the user to copy the text or to directly send it to another generative AI model for generating target content such as images or responses. The server, if requested, forwards the final prompt sentence to another model instance and processes the resulting output.
Input: latest refined prompt sentence and user decision to continue or finalize.
Output: either a further-refined prompt sentence for another feedback cycle or a finalized prompt sentence ready for deployment to a generative AI model for actual content generation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content generation systems that utilize generative AI models are typically configured to accept a static user input and return a one-time generated text. Such systems generally treat the user's input as a flat, unstructured sequence of characters and do not extract higher-level semantic elements such as role, personality, objective, or situation in a systematic manner. As a result, the generated prompt sentences for controlling character behavior and reaction tend to be coarse, difficult to reuse, and difficult to adapt across different scenarios or downstream applications.

Furthermore, in many existing architectures, user editing is handled only as a superficial overwrite of previously generated text. The system does not maintain a persistent, structured representation of the user-edited content and therefore cannot reliably propagate user customizations into subsequent generative steps. This leads to a situation where the computing system repeatedly discards useful editorial signals, increasing computational redundancy and reducing the precision of later generations.

Still further, most known systems do not treat a user's emotional state as a first-class computational input. Emotion, if considered at all, is often handled outside the core generation loop, for example through separate manual tuning of parameters by the user. Computing devices therefore lack a unified pipeline in which multi-modal emotion acquisition data (such as camera images, audio signals, and interaction patterns) are converted into an estimated emotional state and then used to adapt prompt sentences in real time. Without such a pipeline, the system cannot algorithmically adjust writing style, content, or tone of prompt sentences to match the changing emotional context of the user, and cannot efficiently generate emotion-adaptive outputs such as character dialogue, interactive story branches, or content recommendations.

Additionally, typical interactive story engines and recommendation engines operate with preauthored scripts or fixed rule sets. These engines are not optimized to exploit the combination of (i) structured information derived from raw user text, (ii) user-edited customized prompt sentences, and (iii) real-time emotional state. Consequently, computing resources are not used optimally: the system may perform redundant generation, fail to reuse structured semantic information, and be unable to generate contextually coherent story progression or content recommendations that dynamically reflect the current user emotion and editing history.

Accordingly, there is a need for a computer-implemented system that improves the way a processor acquires and structures user input, maintains and updates prompt sentences under user customization, and integrates an emotion estimation pipeline into the core generative process. The technical problem addressed by the present invention is to provide an improved computing architecture in which a processor uses structured representations and real-time emotional state to generate and adapt prompt sentences and downstream response sentences (including character scenes, dialogue, story branches, and content recommendations) in a manner that is more efficient, more reusable, and more responsive than conventional systems.

The specific processing by the specific processing unit 290 of the data processing device 12 in Application Example 2 is realized by the following means.

The present invention provides a server comprising a processor configured to acquire, from a user terminal, character string information and analyze the character string information to generate structured information including role information, personality information, objective information, and situation information; to generate, based on the structured information and by using a generative information processing model, a prompt sentence including a personality prompt sentence that instructs behavior and reactions of a specific role; to present the prompt sentence to the user terminal via a user interface and, based on editing information or additional information acquired from the user terminal, update the prompt sentence to generate a customized prompt sentence; to acquire emotion acquisition data from the user terminal, input the emotion acquisition data into an emotion estimation unit, and estimate an emotional state of a user in real time; to generate, based on the estimated emotional state and the customized prompt sentence and by using the generative information processing model, an emotion-adaptive prompt sentence in which at least one of a writing style, content, or tone of the prompt sentence is dynamically adjusted; and to generate, based on the emotion-adaptive prompt sentence and by using the generative information processing model, a response sentence including at least one of a character behavior scene sentence, a dialogue sentence, a story progression prompt sentence, a creative support prompt sentence, or a content recommendation prompt sentence, and output the response sentence to the user terminal. This enables the computing system to perform an integrated sequence of data transformations—from raw text and multi-modal emotion data to structured information, customized and emotion-adaptive prompt sentences, and downstream response sentences—in a way that reduces redundant generation, improves reuse of semantic structures, and dynamically adapts generated content to the user's real-time emotional state, thereby improving the functioning of the computer system itself in the domains of text generation, interactive storytelling, and content recommendation.

The term “processor” refers to a hardware or virtual computation unit, such as a central processing unit or a processing core, that executes instructions to perform the analysis, generation, and control operations described in the present specification.

The term “user terminal” refers to an information processing apparatus, such as a portable terminal, a desktop terminal, or a head-mounted terminal, that communicates with the server, provides an interface for user input and output, and supplies character string information and emotion acquisition data.

The term “character string information” refers to digital data representing one or more characters, symbols, or words input by the user, including natural language text describing roles, personalities, objectives, situations, or requests.

The term “information processing unit” refers to a functional unit implemented by the processor executing software or firmware that performs operations such as parsing, tokenizing, extracting, or transforming the character string information into structured information.

The term “structured information” refers to data that has been organized into a predetermined format, such as key-value pairs or object fields, including at least role information, personality information, objective information, and situation information, such that it can be directly consumed by a generative information processing model.

The term “role information” refers to data indicating a functional or narrative role associated with a character or entity, such as hero, guide, assistant, or antagonist.

The term “personality information” refers to data indicating characteristic behavioral tendencies or traits of a character or entity, such as bravery, calmness, kindness, or aggressiveness.

The term “objective information” refers to data indicating one or more goals, purposes, or intended outcomes attributed to a character or scenario, such as protecting others, solving a problem, or completing a mission.

The term “situation information” refers to data indicating contextual conditions or circumstances in which a character or scenario is placed, including environment, temporal setting, conflict, or events.

The term “generative information processing model” refers to a trained information processing model that generates output data, such as text, based on input data, using techniques such as probabilistic modeling, machine learning, or neural network processing, and that can produce prompt sentences or response sentences from structured information and other inputs.

The term “prompt sentence” refers to a text string used as an instruction or conditioning input to a generative information processing model, specifying constraints, roles, behaviors, or styles to guide generation of subsequent text.

The term “personality prompt sentence” refers to a prompt sentence that explicitly instructs behavior, reactions, or speaking style of a specific role or character, and that is used to control how the generative information processing model represents that role or character.

The term “user interface” refers to a set of hardware and software components that enable interaction between the user and the system, including display elements, input controls, and communication mechanisms through which prompt sentences and response sentences are presented and edited.

The term “editing information” refers to data representing modifications applied by the user to an existing prompt sentence, including insertion, deletion, or replacement of characters, words, or segments.

The term “additional information” refers to data representing content appended or associated by the user to an existing prompt sentence, such as new traits, scenarios, or constraints that extend the original prompt sentence.

The term “customized prompt sentence” refers to a prompt sentence that has been updated or modified based on editing information or additional information from the user, so that the prompt sentence reflects user-specific preferences or requirements.

The term “emotion acquisition data” refers to data obtained from the user terminal that is suitable for estimating an emotional state of the user, including at least one of image data, audio data, physiological signal data, or interaction pattern data.

The term “emotion estimation unit” refers to a functional unit, implemented by the processor executing an emotion estimation algorithm, that processes emotion acquisition data to output an estimated emotional state of the user.

The term “emotional state” refers to information indicating a psychological or affective condition of the user at a point in time, such as joy, sadness, stress, anxiety, excitement, or calmness, and may be represented as labels, scores, or probability distributions.

The term “emotion-adaptive prompt sentence” refers to a prompt sentence that has been generated or modified based on an estimated emotional state of the user, so that at least a writing style, content, or tone of the prompt sentence is dynamically adjusted to correspond to the emotional state.

The term “writing style” refers to aspects of a prompt sentence relating to linguistic manner of expression, such as formality, complexity, directness, humor, or empathy.

The term “tone” refers to an affective or attitudinal quality of a prompt sentence, such as encouraging, calm, sympathetic, playful, or serious.

The term “response sentence” refers to a text output generated by the generative information processing model based on a prompt sentence, including any combination of character behavior scene sentences, dialogue sentences, story progression prompt sentences, creative support prompt sentences, or content recommendation prompt sentences.

The term “character behavior scene sentence” refers to a sentence or group of sentences that describes actions, movements, or situational behavior of a character in a scene.

The term “dialogue sentence” refers to a sentence that represents spoken or written utterances attributed to a character, including direct speech, questions, or responses.

The term “content recommendation prompt sentence” refers to a prompt sentence that is used to retrieve or generate suggestions of content items, such as media items or information items, in accordance with user preferences, emotional state, or context.

The term “story progression prompt sentence” refers to a prompt sentence that encodes scene information and option information for an interactive narrative, and is used to cause the generative information processing model to produce a next segment of story text or branching options.

The term “scene information” refers to data indicating narrative elements of a story segment, including setting, characters present, current conflict, and immediate events.

The term “option information” refers to data indicating one or more selectable actions or choices presented to the user in the context of an interactive story or decision point.

The term “selection information” refers to data indicating a choice, option, or response selected by the user among a plurality of presented options.

The term “creative support prompt sentence” refers to a prompt sentence generated for the purpose of supporting a creative activity of the user, including information about archetypes, behavior patterns, or content categories that can serve as reference or inspiration.

The term “archetype information” refers to data that specifies a generalized model or pattern of a character, such as hero, mentor, trickster, or caregiver, that can be reused across different narratives.

The term “behavior pattern information” refers to data that specifies typical reactions, decision tendencies, or action sequences of a character type under certain situations.

The term “content category information” refers to data that classifies content into categories such as genre, theme, emotional tone, or medium type, for use in generation or recommendation of content.

The term “server” refers to an information processing system including at least one processor and at least one storage unit, configured to communicate with one or more user terminals over a communication network and to execute the functions described in the present specification.

In one embodiment, a server, one or more terminals, and a communication network together implement the claimed system. The server includes at least one processor, a main memory, a non-volatile storage device, and a network interface. The terminal includes at least one processor, a display unit, an input unit, a microphone, a camera, and a communication interface. The server executes software components including a natural language processing module, a generative AI module, an emotion estimation module, a session management module, and a data storage module. The terminal executes a client application that provides a user interface for inputting text, transmitting multimedia data, and displaying prompt sentences and response sentences.

The server uses a natural language processing library, such as an implementation similar to spaCy executed on a general-purpose processor, to analyze character string information. The server segments the character string information into tokens, performs part-of-speech tagging, and applies named-entity recognition and dependency parsing. The server converts the flat sequence of tokens into a structured information object that includes, as fields, at least role information, personality information, objective information, and situation information. The server stores the structured information in a storage device as a record containing typed fields, for example: a role field, a personality field, an objective field, and a situation field.

The server uses this structured representation as an intermediate format that can be repeatedly reused in subsequent invocations of a generative AI model.

The server uses a generative AI model implemented as a neural network-based language model to generate a prompt sentence from the structured information. In one example, the server uses a transformer-based neural network having multiple self-attention layers, feed-forward layers, and layer normalization layers. The generative AI model stores parameters as floating-point weight matrices and bias vectors associated with attention heads, projection layers, and output layers. The server inputs to the generative AI model a sequence of tokens that includes a fixed instruction phrase and a textual encoding of the structured information. The generative AI model performs attention-based computation over the entire sequence, calculates attention scores for each token pair based on scaled dot products, applies non-linear activation functions, and predicts a next token distribution at each step. The generative AI model samples or selects tokens according to the predicted probability distribution and thus outputs a personality prompt sentence.

The server uses the structured information to constrain generation in a manner that differs from conventional free-form generation. The server encodes role information, personality information, objective information, and situation information as tagged segments, so that the generative AI model receives an input sequence with explicit delimiters and semantic tags.

This input format causes the internal attention mechanism of the neural network to focus on semantically related segments and reduces ambiguity in decoding. As a result, the server reduces the number of tokens required to reach a target level of specificity, which improves generation speed and decreases computational load in the generative AI module.

In one example, the user operates the terminal to input the following natural language description:
“I want a brave knight who fights dragons and protects villagers.”

The terminal transmits this character string information to the server. The server extracts “knight” as role information, “brave” as personality information, “protects villagers” as objective information, and “fights dragons” as part of situation information. The server then constructs a prompt sentence by using the generative AI model, for example:
“This character is a brave knight who always stands between villagers and danger, charging at dragons without hesitation and saying lines like ‘I will protect you, no matter the cost.’”

The server sends this personality prompt sentence to the terminal. The terminal displays the personality prompt sentence in an editable text area. The user edits the text, for example, to:
“This character is a brave knight who always stands between villagers and danger, swinging a flaming greatsword at dragons without hesitation and saying lines like ‘I will protect you, no matter the cost.’”

The terminal returns the edited personality prompt sentence to the server. The server stores the customized prompt sentence in a persistent data store together with the associated structured information. The server thereby preserves both the original semantic structure and the user's editorial changes. The server maintains a version history for each prompt, including a base version derived from the structured information and one or more customized versions produced by user editing. This explicit versioning allows the server to reuse earlier intermediate results and avoid regenerating entire prompt sentences when only partial changes occur, which reduces processing time and network traffic.

The server also receives emotion acquisition data from the terminal. The terminal acquires images from the camera, audio signals from the microphone, and interaction pattern data such as key input timing and screen scrolling behavior. The terminal transmits these signals or extracted features to the server. The server feeds the emotion acquisition data into an emotion estimation module. In one embodiment, the emotion estimation module uses a trained neural network classifier for facial expression recognition and prosody analysis. The classifier includes convolutional layers for processing image frames, recurrent or transformer layers for processing audio features, and a fusion layer that combines multiple modalities into a joint feature space. The server computes feature maps from the raw inputs, applies non-linear activation functions, and outputs an emotional state label such as “joyful,” “sad,” or “stressed,” with associated confidence scores.

The server uses a supervised learning method to train the emotion estimation model in advance, using ground-truth labels collected from annotated datasets. The server minimizes a loss function, such as cross-entropy loss between predicted emotion probabilities and true labels, and updates network weights using an optimization algorithm such as stochastic gradient descent or a variant. The server optionally applies data augmentation techniques, such as random cropping and brightness adjustment for images, and noise injection for audio signals, to improve robustness. This training process enables the server to estimate emotional state on unseen data with reduced error compared to simpler rule-based methods.

The server combines the estimated emotional state with the customized prompt sentence to generate an emotion-adaptive prompt sentence. The server constructs an input sequence to the generative AI model that includes the customized prompt sentence and an annotation indicating the user's emotional state. For example, when the user is stressed, the server constructs an input description such as:
“Rewrite the following character description so that the tone is calm and reassuring to a stressed user, while preserving the key traits and role.”
   followed by the customized prompt sentence. The generative AI model then generates an emotion-adaptive prompt sentence, for example:
“This character is a brave knight who always stands between villagers and danger, swinging a flaming greatsword at dragons without hesitation, yet speaking in a calm and steady voice, saying ‘Take a deep breath, we will face this together, and you are not alone.’”

The server thus uses the estimated emotional state as a conditioning factor that systematically modifies the writing style and tone of the prompt sentence. This modification is not merely a post-processing step; instead, the emotional state is embedded in the input representation so that the neural network uses specialized parameters and attention patterns to adjust lexical choices and sentence structure. This configuration leads to more consistent and context-appropriate adaptation than a manual rule-based insertion of emotional phrases, and reduces the need for multiple distinct prompt templates.

The server further uses the emotion-adaptive prompt sentence to generate response sentences, such as character behavior scene sentences, dialogue sentences, story progression prompt sentences, creative support prompt sentences, and content recommendation prompt sentences. For example, when the user requests an interactive story, the server constructs a prompt sentence:
“Using the following emotion-adaptive character description, generate the opening scene of an interactive fantasy adventure where the character speaks to the user and ends the scene with two choices.”
followed by the emotion-adaptive prompt sentence. The generative AI model then outputs a story segment with concrete actions and dialogue, ending with options like “advance toward the dragon” or “retreat to protect the villagers.” The server encodes both the narrative state and the available options in a structured form, stores them in the session management module, and sends a textual representation to the terminal. The terminal displays the story text and options to the user, who selects an option. The server uses the selected option and the current emotional state to construct a new story progression prompt sentence and continues generation.

The server improves computing efficiency by separating long-lived structured information from transient natural language realizations. The server maintains structured descriptors of roles, personalities, objectives, and situations in a database and passes only compact references and incremental edits through the network. The generative AI model uses the structured descriptors to constrain its search space, which reduces generation time and yields more deterministic behavior compared to unconstrained text generation. The server thereby reduces bandwidth usage between the server and terminals, because the server needs to transmit only prompt sentences and deltas instead of entire context states.

The server also reduces redundant computation in emotional adaptation. In conventional systems, whenever the emotional state changes, the entire content may be regenerated from scratch. In the described system, the server maintains the customized prompt sentence and uses the generative AI model to produce emotion-adaptive variants by applying a transformation conditioned on the emotional state. This reuse of an existing intermediate representation shortens the path from input to final output and decreases processing load. The emotion-adaptive prompt is treated as a derived object, with a clear lineage to the base customized prompt. This explicit lineage is stored in the data storage module and allows caching and selective invalidation. For example, when the user changes an objective in the personality description, the server invalidates only those emotion-adaptive prompts that depend on the changed objective, leaving other session state intact.

The server differs from simple automation of human editing in that the server performs multi-stage, machine-optimized transformations that are difficult to implement through manual rules. The server uses numeric representations (embeddings) for words and structured tags, calculates attention weights to detect long-range dependencies, and applies learned transformations in a high-dimensional vector space. The server thereby discovers patterns in personality and emotional state interactions that are not easily codified by explicit rules. For instance, the server can adjust not only adjectives that reflect mood but also narrative pacing, sentence length, and rhetorical structures. This behavior results in consistent and scalable adaptation across many combinations of role, personality, objective, and emotional state.

The terminal cooperates with the server to realize technical effects in human-computer interaction. The terminal uses its camera and microphone to acquire high-resolution signals and performs pre-processing such as downsampling and feature extraction, thereby reducing the volume of data sent to the server. The terminal can detect conditions such as low-light environment or high background noise and can adjust capture parameters accordingly, which improves the reliability of emotion estimation on the server. The terminal also manages interface updates efficiently; by receiving only updated prompt sentences and response sentences, the terminal can apply differential rendering on the display, which reduces redraw operations and conserves local computing resources.

In another embodiment, the server uses alternative neural network architectures for the generative AI model and the emotion estimation model. The server can employ a recurrent neural network with gating units instead of a transformer for text generation, or a graph-based neural network for context modeling. The server can also incorporate a hybrid rule-based layer on top of the generative AI model to enforce domain-specific constraints, such as prohibited phrases or consistent use of names. The server can maintain configuration profiles that define the relative weighting of neural outputs and rule-based adjustments, and can adapt these profiles based on observed user interactions.

In yet another embodiment, the server supports multiple terminals per user, such as a smartphone and a head-mounted display. The server associates emotion acquisition data from different terminals based on temporal synchronization and device identifiers, and fuses them in the emotion estimation module. This multi-device integration provides more reliable emotional state estimation and allows the server to select appropriate response sentences for different display form factors. For example, the server can generate shorter, more succinct prompt sentences for small displays and more elaborate descriptions for large displays, while preserving the same underlying structured information and emotional adaptation.

In a further embodiment, the server uses the generative AI model to create creative support prompt sentences based on user requests such as “Give me an idea for a new fantasy hero.”

The server combines such requests with the emotional state and outputs, for example:
“Create a character who is a courageous wanderer, traveling from village to village to help those in need. Describe how they confront danger, how they speak to frightened villagers, and how they react when they are injured but must continue.”

The server presents this creative support prompt sentence to the user via the terminal, and the user can use it as a reference for further prompt design. The server handles these creative support prompt sentences in the same structured manner, storing them as objects with fields for archetype information, behavior pattern information, and content category information.

This uniform handling enables indexing and retrieval, so that similar creative support prompts can be clustered or recommended based on semantic similarity and emotional fit.

The described system therefore improves computer technology in several ways. The server reduces computational cost by reusing structured intermediate representations and by constraining generative operations with these representations. The server improves accuracy and consistency of prompt sentence generation and emotional adaptation by using trained neural network models with explicit conditioning on structured fields and emotional state.

The server reduces communication load between server and terminals by transmitting compact representations and incremental updates. The server enhances data management by maintaining versioned prompt objects, structured descriptors, and emotional profiles in a persistent storage layer, enabling efficient querying and selective regeneration. The joint use of structured representations, multi-modal emotion estimation, and generative AI models, under a specific data flow and module configuration, provides technical effects beyond merely automating human prompt writing, and enables the computing system to generate, adapt, and deliver prompt sentences and response sentences in a more efficient and technically advantageous manner.

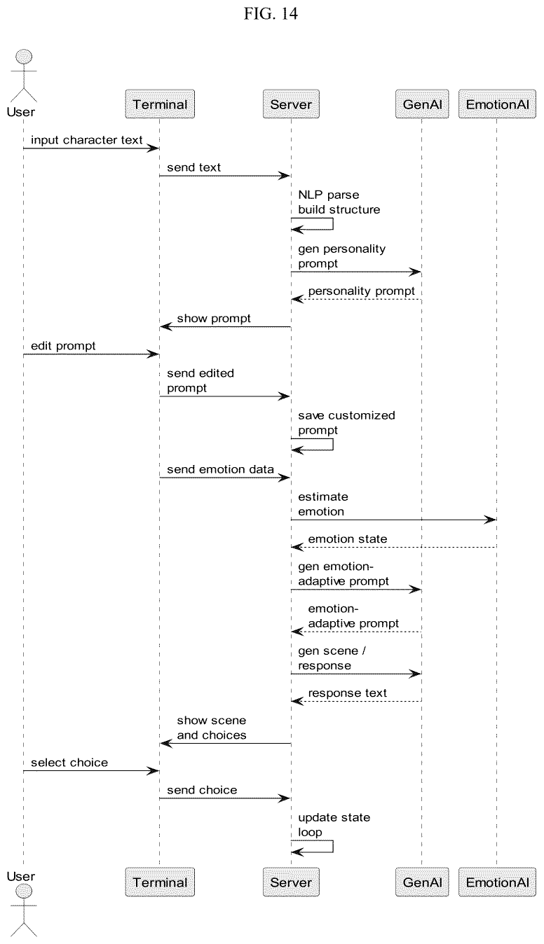

The following describes the processing flow using FIG. 14.

### Step 1:

User operates the terminal to open a character creation screen and inputs character string information.
User enters, as input, a natural language description such as “I want a brave knight who fights dragons and protects villagers.”
Terminal receives this text, performs basic validation on length and encoding, and packages the text together with user identification into a request message.
Terminal outputs a structured request payload, for example including fields for user ID, timestamp, and the raw character string, and transmits this payload to the server over a communication network.

### Step 2:

Server receives the request payload from the terminal and extracts the character string information as input for natural language processing.
Server applies a natural language processing module, implemented for example with a library similar to spaCy, to tokenize the text, perform part-of-speech tagging, and detect named entities.
Server performs data processing in which the tokens and dependency relations are analyzed to identify role terms, personality descriptors, objective phrases, and situation phrases.
Server outputs structured information that includes at least role information, personality information, objective information, and situation information, stored as typed fields in an internal object.

### Step 3:

Server uses the structured information as input to construct an input sequence for a generative AI model.
Server concatenates an instruction phrase, such as “Create a detailed personality description for the following role, traits, objective, and situation,” with a textual encoding of the structured fields.
Server converts the combined text into token IDs using a tokenizer corresponding to the generative AI model, and outputs a token sequence that serves as the model input.

### Step 4:

Server inputs the token sequence into the generative AI model implemented as a neural network-based language model.
Server causes the model to perform data computations including embedding lookup, self-attention operations, feed-forward network operations, and softmax probability calculation for each output token position.
Server uses a decoding strategy such as greedy decoding or top-k sampling to iteratively select output tokens based on the computed probability distributions.
Server outputs a generated personality prompt sentence, for example: “This character is a brave knight who always stands between villagers and danger, charging at dragons without hesitation and saying lines like ‘I will protect you, no matter the cost.’”

### Step 5:

Server stores, as input to a persistence operation, both the structured information and the generated personality prompt sentence along with metadata such as user ID and timestamp.
Server writes these data into a storage device, assigning a unique identifier to the prompt object and establishing links between the structured fields and the generated text.
Server outputs a response message containing at least the personality prompt sentence and its identifier and sends this response to the terminal.

### Step 6:

Terminal receives the response message from the server and extracts the personality prompt sentence and identifier as input for the user interface update.
Terminal displays the personality prompt sentence in a text editing component, enabling cursor movement, insertion, deletion, and replacement operations.
User reviews the displayed text and performs specific editing actions, for example changing “charging at dragons” to “swinging a flaming greatsword at dragons.”
Terminal monitors the editing operations, updates an internal copy of the text after each change, and outputs the final edited prompt sentence when the user activates a save or confirm control.

### Step 7:

Terminal sends the edited personality prompt sentence and the associated identifier to the server as input for customization registration.
Server receives this input, compares the edited text with the original, and performs data processing to record differences such as added phrases and removed phrases.
Server assigns a new version number to the edited text, updates the prompt object in the storage device to include the customized prompt sentence, and marks it as user-approved.
Server outputs a confirmation message indicating successful storage of the customized prompt sentence and returns the confirmation to the terminal.

### Step 8:

Terminal acquires emotion acquisition data from local sensors as input for emotion estimation.
Terminal captures video frames from the camera, audio samples from the microphone, and optionally interaction features such as typing intervals and touch gestures.
Terminal optionally preprocesses this data by downsampling, cropping, or extracting basic features to reduce size, and outputs the preprocessed emotion acquisition data to the server via the communication interface.

### Step 9:

Server receives the emotion acquisition data as input to an emotion estimation module.
Server applies a trained neural network classifier that processes image features and audio features to compute internal feature vectors.
Server performs data computation in which convolutional layers, recurrent or transformer layers, and a fully connected output layer transform the input features into a probability distribution over multiple emotional states.
Server outputs an estimated emotional state, such as “stressed” with a confidence score, and stores this state in association with the current user session.

### Step 10:

Server retrieves the latest customized prompt sentence from the storage device as input, together with the estimated emotional state.
Server constructs a new instruction text such as “Rewrite the following character description so that the tone is calm and reassuring to a stressed user, while preserving the key traits and role,” concatenated with the customized prompt sentence.
Server tokenizes this combined text to obtain a new input token sequence for the generative AI model and outputs the token sequence as model input.

### Step 11:

Server inputs the token sequence and the emotional state context into the generative AI model and causes the model to generate an emotion-adaptive prompt sentence.
Server allows the model to perform the same sequence of neural computations as in earlier generation, but now with the emotional state embedded in the input representation, influencing attention patterns and token probabilities.
Server decodes the model output to obtain a revised character description, for example: “This character is a brave knight who always stands between villagers and danger, swinging a flaming greatsword at dragons without hesitation, yet speaking in a calm and steady voice, saying ‘Take a deep breath, we will face this together, and you are not alone.’”
Server outputs this emotion-adaptive prompt sentence and records it as a derived version of the customized prompt sentence.

### Step 12:

Server uses the emotion-adaptive prompt sentence as input to generate one or more response sentences for downstream applications.
Server constructs a higher-level instruction such as “Using the following emotion-adaptive character description, generate an opening scene for an interactive story that ends with two user choices,” appends the emotion-adaptive prompt sentence, and tokenizes the result.
Server feeds the token sequence into the generative AI model and computes a scene text that includes narrative description, character behavior, and dialogue, followed by choice options.
Server outputs a response package containing the generated character behavior scene sentence, dialogue sentences, and encoded choice options.

### Step 13:

Server sends the response package to the terminal as input for user interaction.
Terminal receives the package, parses the scene text and choice options, and updates the user interface to display the story segment and selectable buttons or menu entries representing the options.
User reads the story and selects one option, such as “advance toward the dragon” or “retreat to protect the villagers.”
Terminal records the selected option, creates selection information including the chosen label and timestamp, and outputs this selection information to the server.

### Step 14:

Server receives the selection information and the latest emotional state as input for continuing the interactive session.
Server updates the stored story state to reflect the branch corresponding to the selected option and logs the selection as part of the session history.
Server constructs a new story progression prompt sentence that encodes the updated context and again includes the emotion-adaptive prompt sentence or a newly adapted version if the emotional state has changed.
Server outputs a new model input to the generative AI model, receives the next segment of story text, and continues the cycle of generating response sentences and sending them to the terminal.

### Step 15:

Server optionally uses the emotion-adaptive prompt sentence and the structured information as input to generate creative support prompt sentences or content recommendation prompt sentences.
Server builds an instruction text such as “Based on this character and the user's current emotional state, describe an idea for another related character who could appear in the story,” or “Describe a playlist of calm, relaxing music that could help the user unwind after a long day.”
Server inputs the instruction to the generative AI model, which computes and outputs a creative support prompt sentence or a content recommendation prompt sentence.
Server outputs these sentences to the terminal, where the user can view them as inspiration or can trigger external content retrieval based on the recommendation prompt.

### Step 16:

Server continuously manages data structures and caches as input for optimization of future operations.
Server monitors which prompt sentences and emotion-adaptive variants are frequently reused and stores their tokenized forms and intermediate neural activations in a cache.
Server, when receiving new requests that reference the same structured information and similar emotional states, retrieves cached representations and performs only incremental computations, thereby reducing processing time and energy consumption.
Server outputs generated prompt sentences and response sentences more quickly due to this reuse, and terminal receives updated content with reduced latency, improving the overall responsiveness of the system.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

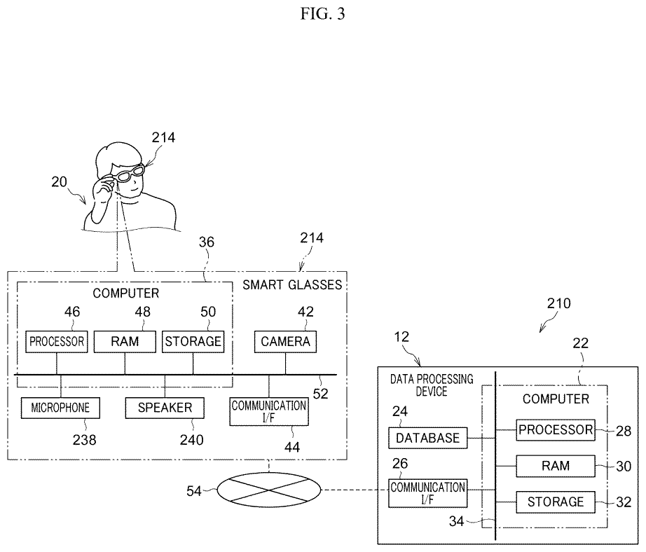

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

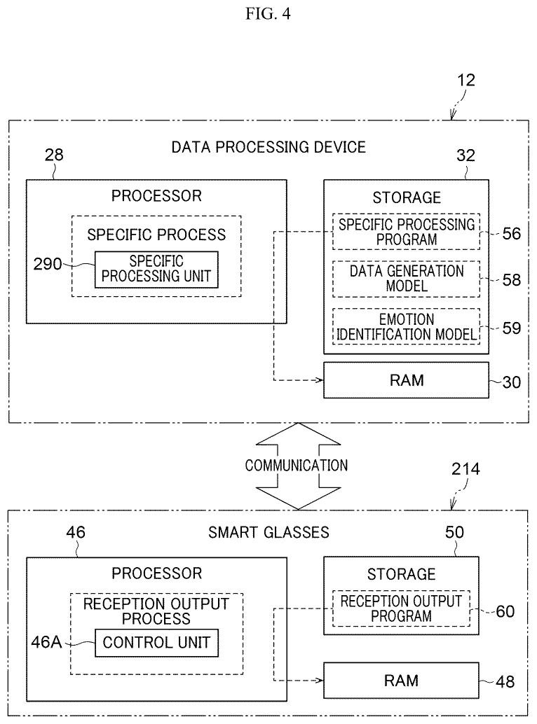

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

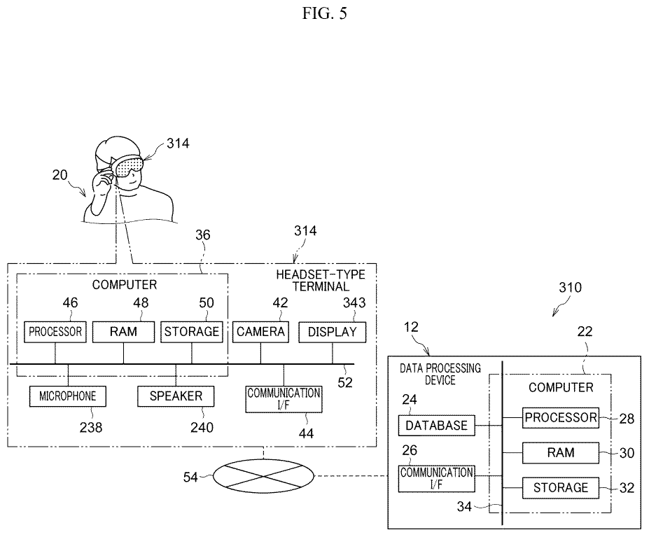

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

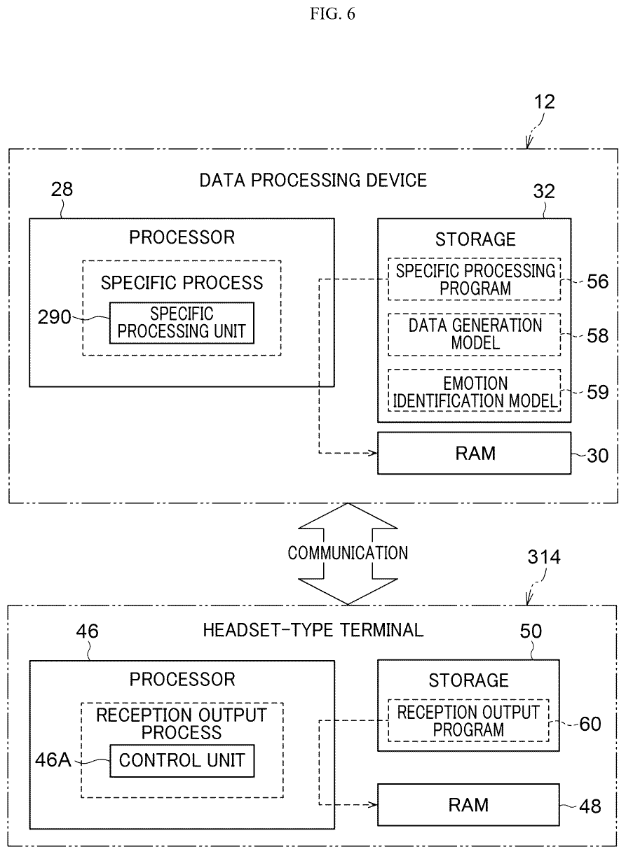

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

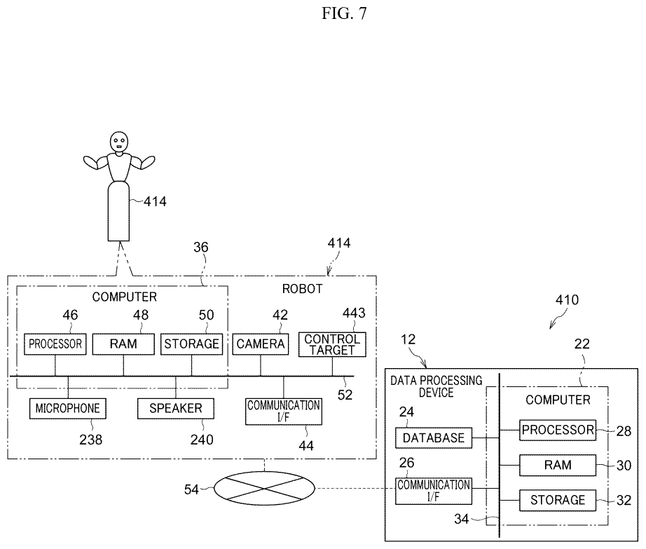

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

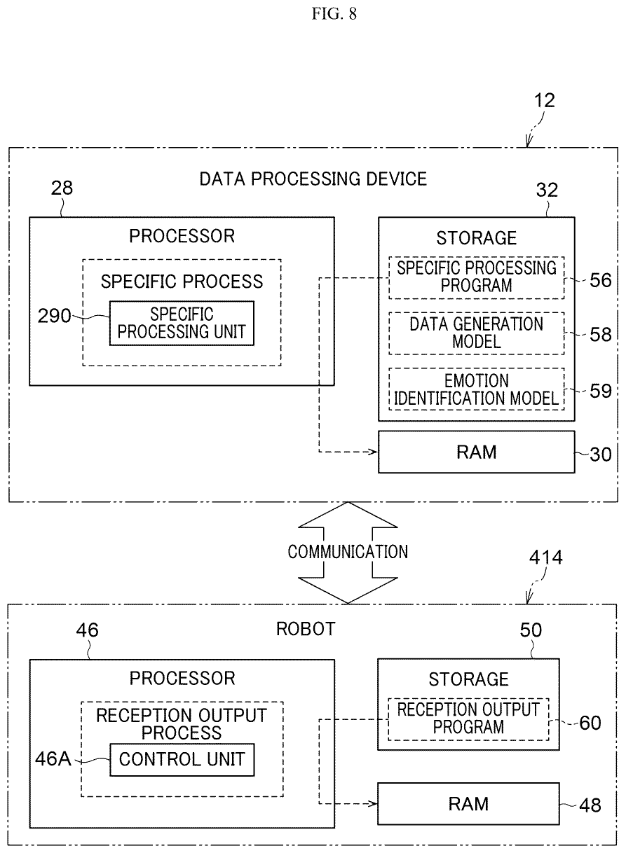

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

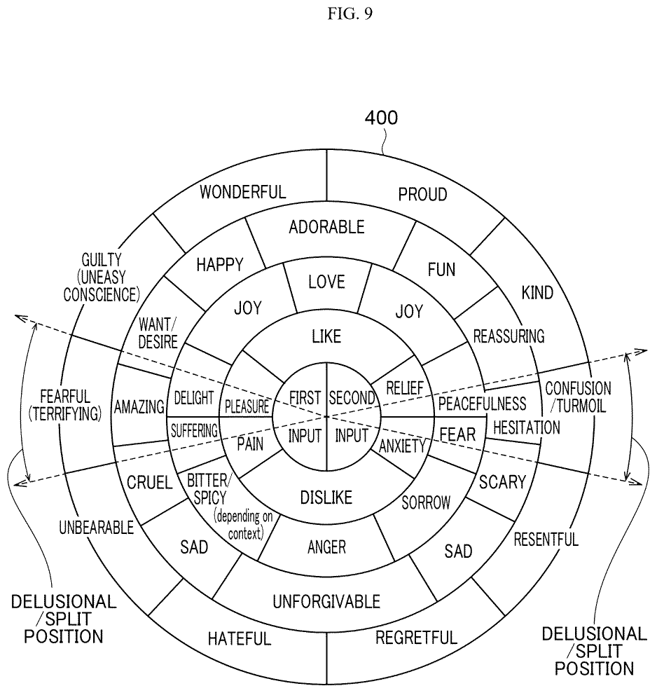

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

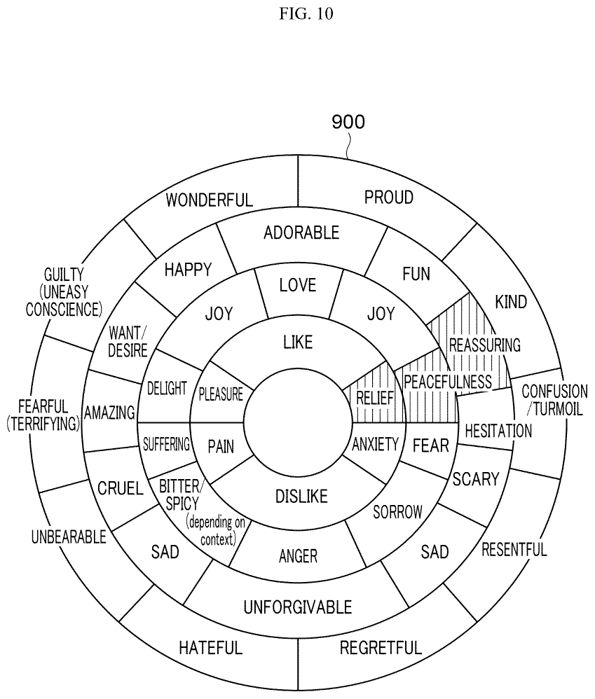

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive character description text from a terminal, normalize the character description text,
perform natural language processing on the normalized character description text to extract attribute information and behavior information of a person, and convert the extracted attribute information and behavior information into structured data, and
generate, based on the structured data, an input sentence for a generative AI model, cause the generative AI model to generate a prompt sentence as a personality prompt that instructs actions and reactions of the person, and control an expression format and a length of the prompt sentence so that the prompt sentence is in a form of instructions directed to the person, and
output the generated prompt sentence to the terminal, enable a user to customize the prompt sentence by editing or adding to the prompt sentence via an interface of the terminal, and
present a customized prompt sentence as a prompt sentence to be input to another generative AI model, and
acquire an emotional state of the user based on operation information of the user and state information obtained from the terminal, and dynamically change an input condition to the generative AI model or contents of the prompt sentence in accordance with the acquired emotional state of the user.

### Supplementary 2

The system according to supplementary 1,
wherein the processor is configured to
generate the structured data by integrating synonymous expressions in the character description text into higher-level concepts using the natural language processing, and
generate, in accordance with role information, personality information, and typical behavior information included in the structured data, the prompt sentence as the personality prompt that includes specific action instructions in a plurality of situations.

### Supplementary 3

The system according to supplementary 1,
wherein the processor is configured to
present candidate phrases and sample prompt sentences, generated on the basis of the structured data and the generative AI model, as reference information when the user creates a new prompt sentence as the personality prompt.

### Application Example 1

### Supplementary 1

A system comprising a processor,
wherein the processor is configured to
acquire, via a communication unit, attribute information related to a character and user-related information received from a user terminal,
automatically generate, based on the acquired attribute information, a prompt sentence including a personality prompt that instructs specific actions and reactions of the character by performing natural language processing using a generative AI model,
enable the automatically generated personality prompt to be customized by allowing a user to edit or add to the personality prompt via a user interface on the user terminal, and receive, from the user terminal, a customized personality prompt,
automatically generate, in the processor, a story corresponding to characteristics of the character by performing natural language processing using the generative AI model based on the customized personality prompt and the attribute information,
divide the automatically generated story into a plurality of text segments and sequentially transmit the text segments in real time to the user terminal using a network communication method,
control the user terminal to present the story in real time by sequentially displaying the transmitted text segments on the user terminal,
acquire a user emotional state or user behavior history and dynamically adjust generation conditions for the personality prompt or the story according to the acquired emotional state or behavior history, and
in a case where different attribute information is selected by the user, automatically regenerate the personality prompt and the story based on the different attribute information and present the regenerated story to the user terminal as a different story development.

### Supplementary 2

The system according to supplementary 1,
wherein the processor is configured to generate, using the generative AI model, in addition to the personality prompt that instructs actions and reactions of the character, a prompt sentence including a scene setting of the story, a narrative style, and a length constraint, and to use the prompt sentence as input to the generative AI model for automatically generating the story.

### Supplementary 3

The system according to supplementary 1,
wherein the processor is configured to generate, using the generative AI model, text information including candidate character attribute information, example personality prompts, and example story developments as reference information when the user designs a new personality prompt or new character attribute information, and to present the text information via the user interface.

### Example 2

### Supplementary 1

A system comprising a processor,
wherein the processor is configured to
acquire information from a user through an interface of a terminal device,
generate, on the basis of the acquired information, an initial prompt sentence including a personality prompt sentence that instructs specific behavior or reaction, by using a natural language processing technique and a generative artificial intelligence model,
transmit the initial prompt sentence to the terminal device, cause the terminal device to display the initial prompt sentence, and accept editing or addition to the displayed initial prompt sentence by the user via the interface so as to enable customization of the initial prompt sentence,
store, in a storage device, a customized prompt sentence edited or added by the user on the terminal device,
input the customized prompt sentence to the generative artificial intelligence model and cause the generative artificial intelligence model to generate feedback information including evaluation information and improvement proposals with respect to the customized prompt sentence,
transmit the feedback information to the terminal device and support refinement of the prompt sentence by the user by enabling iterative adjustment of the customized prompt sentence on the basis of the feedback information, and
acquire an emotional state of the user as time-varying information and dynamically adjust content or expression of the prompt sentence including the personality prompt sentence in accordance with the emotional state.

### Supplementary 2

The system according to supplementary 1,
wherein the processor is configured to
generate, by using the generative artificial intelligence model, a prompt sentence that instructs behavior or reaction of a specific virtual target so as to include the prompt sentence in the initial prompt sentence or the customized prompt sentence, and perform iterative editing assistance for the prompt sentence on the basis of the feedback information.

### Supplementary 3

The system according to supplementary 1,
wherein the processor is configured to
provide, by using the generative artificial intelligence model, guidance information as the feedback information when the user devises a new personality prompt sentence, the guidance information including candidates of personality settings, candidates of behavior instructions, candidates of expression styles, and improvement proposals for the candidates.

### Application Example 2

### Supplementary 1

A system comprising a processor,
wherein the processor is configured to
acquire, from a user terminal, character string information, analyze the character string information by an information processing unit, and generate structured information including role information, personality information, objective information, and situation information, and
generate, by using a generative information processing model and based on the structured information, a prompt sentence including a personality prompt sentence that instructs behavior and reactions of a specific role, and
present the prompt sentence to the user terminal via a user interface, acquire editing information or additional information from the user terminal, and update the prompt sentence based on the editing information or the additional information to generate a customized prompt sentence, and
acquire emotion acquisition data from the user terminal, input the emotion acquisition data into an emotion estimation unit, and estimate an emotional state of a user in real time, and generate, by using the generative information processing model and based on the estimated emotional state and the customized prompt sentence, an emotion-adaptive prompt sentence in which a writing style, content, or tone of the prompt sentence is dynamically adjusted, and
generate, by using the emotion-adaptive prompt sentence and the generative information processing model, a response sentence including at least one of a character behavior scene sentence, a dialogue sentence, and a content recommendation prompt sentence, and output the response sentence to the user terminal.

### Supplementary 2

The system according to supplementary 1,
wherein the processor is configured to sequentially generate, by using the generative information processing model and based on the personality prompt sentence or the emotion-adaptive prompt sentence, a story progression prompt sentence including scene information and option information of an interactive story, and to branch and generate the story progression prompt sentence according to selection information of the user and the emotional state of the user.

### Supplementary 3

The system according to supplementary 1,
wherein the processor is configured to generate, by using the generative information processing model and based on request information acquired from the user and the emotional state of the user, a creative support prompt sentence including at least one of archetype information of a character, behavior pattern information, and content category information, and to present the creative support prompt sentence via the user interface as reference information for a creative activity of the user.

What is claimed is:

1. A system comprising:
circuitry configured to:
receive, via a communication interface coupled to a packet-switched network, character description text from a terminal device, normalize the character description text, and apply natural language processing to extract attribute information and behavior information of a described entity;
convert the extracted attribute information and behavior information into structured data, generate a prompt sentence based on the structured data, and input the prompt sentence to a generative AI model to automatically generate a personality prompt that instructs a specific behavior or reaction; and
enable the generated personality prompt to be customized by receiving an edit or addition from the terminal device via the communication interface, monitor an emotional state of the user in real time, and dynamically adjust the personality prompt based on the monitored emotional state.

2. The system according to claim 1, wherein the circuitry is configured to receive character description text from the terminal device via the communication interface, normalize the character description text, and apply natural language processing to extract attribute information including at least personality traits, behavioral tendencies, and communication patterns.

3. The system according to claim 2, wherein the circuitry is configured to convert the extracted attribute information and behavior information into structured data, and generate the prompt sentence incorporating the structured data and an instruction for the generative AI model to generate a personality prompt specifying the behavior or reaction of the described entity.

4. The system according to claim 3, wherein the circuitry is configured to receive the generated personality prompt from the generative AI model, transmit the personality prompt to the terminal device for display, and receive an edit or addition to the personality prompt from the terminal device via the communication interface.

5. The system according to claim 4, wherein the circuitry is configured to incorporate the received edit or addition into the personality prompt, regenerate the structured data based on the updated personality prompt, and store the updated personality prompt in a storage device in association with an entity identifier.

6. The system according to claim 1, wherein the circuitry is configured to monitor the emotional state of the user in real time by applying an emotion analysis engine to data received from the terminal device via the communication interface.

7. The system according to claim 6, wherein the circuitry is configured to detect a change in the emotional state of the user exceeding a threshold, generate an updated personality prompt incorporating the detected emotional state change, and transmit the updated personality prompt to the terminal device.

8. The system according to claim 1, wherein the circuitry is configured to use the generative AI model to generate reference information for the user when considering a new personality prompt, and transmit the reference information to the terminal device via the communication interface.

9. The system according to claim 8, wherein the circuitry is configured to generate the reference information by inputting a prompt sentence incorporating the current personality prompt and user context data to the generative AI model, and obtain suggestions for new personality prompt elements as the reference information.

10. The system according to claim 1, wherein the circuitry is configured to store a plurality of personality prompts in the storage device in association with respective entity identifiers, and retrieve a stored personality prompt for application to a designated entity based on a selection received from the terminal device.

11. The system according to claim 10, wherein the circuitry is configured to apply the retrieved personality prompt to a generative AI model to generate behavioral responses consistent with the personality defined by the prompt, and transmit the generated responses to the terminal device via the communication interface.

12. The system according to claim 1, wherein the circuitry is configured to receive, from the terminal device, a query directed to a described entity, generate a prompt sentence incorporating the personality prompt and the query, input the prompt sentence to the generative AI model, and obtain a response consistent with the personality defined by the prompt.

13. The system according to claim 12, wherein the circuitry is configured to adjust the generated response based on the monitored emotional state of the user, and transmit the adjusted response to the terminal device via the communication interface.

14. The system according to claim 1, wherein the circuitry is configured to detect inconsistencies between the extracted attribute information and the generated personality prompt, and regenerate the prompt sentence to request a revised personality prompt from the generative AI model.

15. The system according to claim 14, wherein the circuitry is configured to compare the revised personality prompt against the extracted structured data to verify consistency, and store the verified personality prompt in the storage device.

16. The system according to claim 1, wherein the circuitry is configured to receive session interaction data from the terminal device via the communication interface, update the structured data based on the session interaction data, and regenerate the personality prompt for subsequent sessions.

17. The system according to claim 16, wherein the circuitry is configured to detect changes in the monitored emotional state of the user across sessions, incorporate the detected changes into the structured data, and adjust the personality prompt to reflect the emotional context of the user.

18. A system comprising:
circuitry configured to:
receive, via a communication interface coupled to a packet-switched network, character description text from a terminal device, apply natural language processing to extract attribute information and behavior information, and convert the extracted information into structured data;
generate a prompt sentence based on the structured data, input the prompt sentence to a generative AI model to generate a personality prompt, and enable the personality prompt to be customized via the terminal device;
monitor an emotional state of the user in real time using an emotion analysis engine, and dynamically adjust the personality prompt based on the monitored emotional state; and
transmit the updated personality prompt to the terminal device via the communication interface, and store the personality prompt in a storage device in association with an entity identifier.

19. The system according to claim 18, wherein the circuitry is configured to receive a query from the terminal device directed to a described entity, generate a prompt sentence incorporating the personality prompt and the query, input the prompt sentence to the generative AI model, and transmit a response consistent with the personality prompt to the terminal device.

20. A method comprising:
receiving, via a communication interface coupled to a packet-switched network, character description text from a terminal device, normalizing the character description text, and applying natural language processing to extract attribute information and behavior information;
converting the extracted attribute information and behavior information into structured data, generating a prompt sentence based on the structured data, and inputting the prompt sentence to a generative AI model to generate a personality prompt; and
enabling the generated personality prompt to be customized by receiving an edit from the terminal device via the communication interface, monitoring an emotional state of the user, and dynamically adjusting the personality prompt based on the monitored emotional state.
